(19) United States
(12) Patent Application Publication
(10) Pub. No.: US 2026/0288622 A1
(43) Pub. Date: Sep. 24, 2026

(54) SYSTEM

(71) Applicant: SoftBank Group Corp., Tokyo (JP)

(72) Inventor: Takao ONISHI, Tokyo (JP)

(73) Assignee: SoftBank Group Corp., Tokyo (JP)

(21) Appl. No.: 19/558,560

(22) Filed: Mar. 6, 2026

(30) Foreign Application Priority Data
Mar. 19, 2025 (JP) 2025-044540

(51) Int. Cl. G06F 11/3668; G06F 8/41; G06N 3/0455

(52) U.S. Cl. CPC G06F 11/368; G06F 8/433; G06N 3/0455

(57) ABSTRACT

A system includes a processor that is configured to receive requirements and specifications input by a user, generate a prompt for instructing a generative AI model to analyze the received requirements and specifications and input the prompt to the generative AI model, and generate test cases based on an analysis result received from the generative AI model.

### CROSS-REFERENCE TO RELATED APPLICATION

This application is based on and claims priority under 35 USC 119 from Japanese Patent Application No. 2025-044540 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In software development projects, tests performed prior to the release or introduction of new functions are often insufficient in scope or depth, resulting in defects that escape detection and appear in the market. Conventional test design processes rely heavily on manual work by test engineers, who must interpret complex requirements and specifications, derive appropriate test scenarios, and identify high-risk areas. This manual process is time-consuming, subject to human oversight, and highly dependent on the experience and intuition of individual engineers. As a result, important edge cases and combinations of conditions may be omitted, and similar past defect patterns may not be fully leveraged, leading to recurring defects. In particular, conventional systems do not effectively utilize generative AI models to systematically analyze requirements and specifications, nor do they use such models to build prediction models that can identify potential defects based on past data and prior analysis results. Therefore, there is a need for a system that can automatically analyze requirements and specifications using a generative AI model, generate appropriate test cases, and further construct prediction models that identify potential defects, thereby preventing defects that have previously been overlooked before introduction and have led to defects in the market.

### SUMMARY

To solve the above-described problems, according to one aspect of the present invention, there is provided a system comprising a processor, wherein the processor is configured to receive requirements and specifications input by a user, generate a prompt for instructing a generative AI model to analyze the received requirements and specifications, input the prompt to the generative AI model, and generate test cases based on an analysis result received from the generative AI model. The processor is further configured to generate, in order to solve a problem in which tests performed upon introduction of a new function are insufficient and defects occur in a market, a prompt for instructing the generative AI model to perform the analysis by referring to past data and taking into account similar cases. In addition, the processor is configured to generate, in order to prevent in advance defects that have previously been overlooked before introduction and have led to defects in a market, a prompt for instructing the generative AI model to construct a prediction model based on the analysis result and to identify potential defects. By causing the generative AI model to analyze requirements and specifications in view of past data, to generate test cases from the obtained analysis results, and to build a prediction model that identifies potential defects, the system expands test coverage, focuses testing on high-risk areas, and reduces the occurrence of defects in the market.

The term “processor” refers to a hardware or software computational entity, including but not limited to a central processing unit (CPU), microprocessor, microcontroller, programmable logic device, or a combination of such elements executing software, that is capable of performing logical operations and controlling execution of the processes described in the present specification and claims.

The term “requirements and specifications” refers to documents, data, or information, expressed in natural language, structured language, models, or diagrams, that describe intended functions, behaviors, performance conditions, constraints, interfaces, and other characteristics of a software system or feature to be developed or modified.

The term “user” refers to a human operator, such as a developer, test engineer, product owner, or other person involved in software development or quality assurance, who inputs requirements and specifications into the system and utilizes outputs, including generated test cases and identified potential defects.

The term “prompt” refers to data, typically expressed as text or structured text, that is generated by the processor and supplied to a generative AI model in order to instruct the generative AI model to perform a specific processing operation, such as analysis of requirements and specifications, construction of a prediction model, or identification of potential defects.

The term “generative AI model” refers to an artificial intelligence model, such as a large language model or other machine learning model capable of generating text or structured outputs, that receives a prompt and produces an analysis result, prediction model information, or other generated content based on training data and the prompt.

The term “analysis result” refers to information generated by the generative AI model in response to a prompt instructing analysis of requirements and specifications, the information including, for example, identified functions, constraints, edge cases, inferred behaviors, or other structured or unstructured data characterizing the target system or feature. The term “test cases” refers to structured descriptions of tests to be executed for verification or validation of a system or feature, each description including at least part of preconditions, input data, execution steps, and expected results, and optionally including attributes such as priority, type, or associated requirement.

The term “past data” refers to data collected in advance of the current analysis, including but not limited to historical requirements, specifications, test cases, defect records, operation logs, and prior analysis results, which can be referenced by the generative AI model in order to improve analysis and prediction.

The term “similar cases” refers to past cases, such as previous requirements, features, test cases, or defects, that exhibit similarity to a target requirement or specification in terms of function, architecture, input and output patterns, domain, or other characteristics, and that are taken into account by the generative AI model when performing analysis.

The term “prediction model” refers to a model, which may be implicit in or explicitly represented by the generative AI model output, that estimates or infers the likelihood, location, or characteristics of potential defects based on the analysis result, past data, and similar cases.

The term “potential defects” refers to defects that have not yet manifested in a released system but are predicted or inferred, by the prediction model or analysis result, to be likely to occur under certain conditions, including functional errors, performance issues, security vulnerabilities, or usability problems.

The term “defects that occur in a market” refers to failures, malfunctions, or undesired behaviors of a released system that are detected after deployment to end users or customers, including bugs reported from production environments or field operations.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

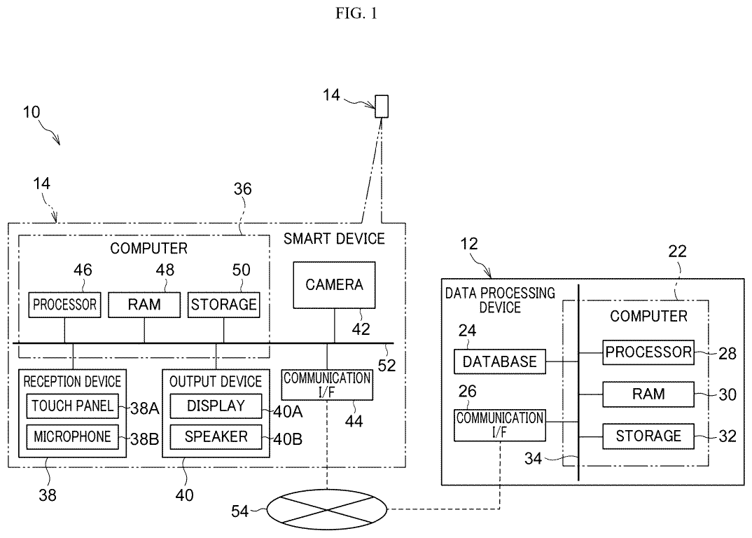

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

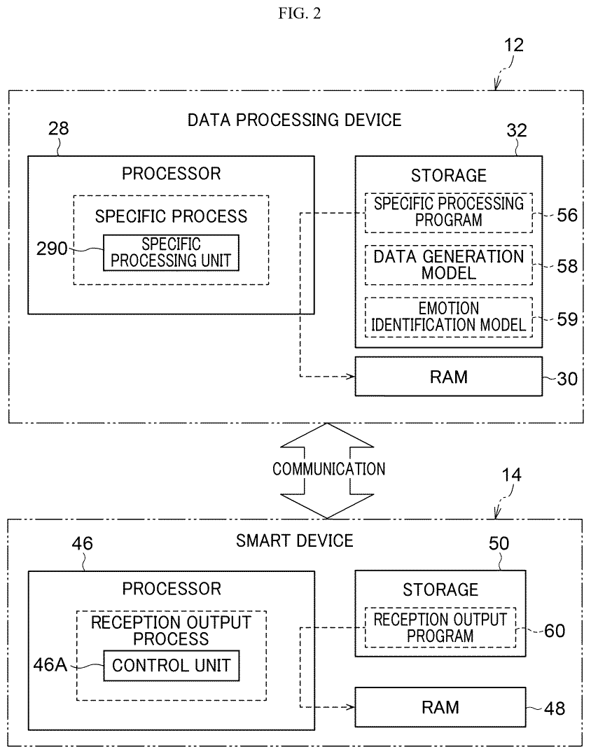

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional techniques for deriving software test cases from natural-language requirements rely heavily on manual interpretation by human engineers. A processor typically receives requirement documents as unstructured text and stores them as static records, but does not perform deep syntactic and semantic analysis. As a result, test case design depends on the subjective judgment and experience of individual testers, which frequently leads to insufficient coverage of normal and abnormal scenarios, overlooked edge cases, and inconsistent handling of quality and safety risks. These limitations manifest as defects that remain undetected until after deployment, causing failures in a production environment and increasing maintenance costs.

In addition, known systems that utilize machine learning or rule-based engines often treat requirement analysis, test case generation, and defect risk estimation as separate, loosely coupled processes. A conventional processor may apply a statistical model to historical data, but does not dynamically orchestrate an adaptive generative model with context-dependent prompt sentences that specify which information to extract, how to structure it, and how to reuse it in subsequent stages of test design and defect prediction. Consequently, the system cannot effectively integrate requirement structures, generated test scenarios, historical defect patterns, and risk prioritization into a unified data flow, and cannot systematically improve test coverage and defect prevention as requirements evolve.

Furthermore, typical natural-language processing pipelines are static and model-centric: they focus on training or calling a model with a fixed input format, rather than programmatically constructing prompt sentences that instruct a generative model to perform multi-step reasoning, such as (i) structuring requirements, (ii) generating test cases, (iii) extracting important test points, and (iv) inferring potential defect factors. Without such prompt-level control logic, the processor has limited ability to tailor the generative model's behavior to different phases of the development lifecycle or to different types of quality risks, which constrains the technical effectiveness of the underlying computer system.

Accordingly, there is a need for an improved computer-implemented technique in which a processor itself generates and sequences prompt sentences for a generative AI model, uses the model to convert unstructured requirement text into structured data, automatically produces normal and abnormal test cases, extracts and ranks important test points, and combines these with accumulated defect case information and defect pattern information to identify potential defect factors prior to deployment. Such a technique should improve the functioning of the computer system by enabling more accurate automated analysis, reducing manual effort, increasing the consistency and coverage of generated test artifacts, and more effectively preventing defects in a real-world environment.

The specific processing by the specific processing unit 290 of the data processing device 12 in Example 1 is realized by the following means.

The present invention provides a server comprising a processor configured to receive, from a user terminal, character information including functional requirements and performance requirements; to generate a first prompt sentence that defines extraction items and an output format for syntactic information and semantic information of the received character information, and to input the first prompt sentence and the character information into a generative information processing model to acquire structured data of the character information; to generate, based on the structured data, test case information including normal operation scenarios and abnormal operation scenarios and having elements including a test identifier, a precondition, input information, operation steps, and an expected result; to use the generated test case information as input data to the generative information processing model, to generate a second prompt sentence to extract points of interest related to quality risk and safety risk, and to input the second prompt sentence and the test case information into the generative information processing model to acquire important test point information; to generate a third prompt sentence that instructs the generative information processing model to refer to the structured data, the test case information, the important test point information, accumulated defect case information, and defect pattern information, and to input the third prompt sentence into the generative information processing model to acquire defect factor information that identifies potential defect factors leading to occurrence of defects in a market; and to store, in a storage unit, the structured data, the test case information, the important test point information, and the defect factor information in association with one another and to generate output information to be provided to an external apparatus. This enables the computer system to automatically transform unstructured requirement text into linked structured artifacts spanning requirements, test cases, important test points, and defect factors through coordinated prompt-driven interactions with a generative AI model, thereby improving the technical performance of requirement analysis and test design processing, enhancing test coverage and risk prioritization, and reducing the likelihood of undiscovered defects in a deployed environment.

The term “processor” refers to a hardware execution unit, or a combination of hardware execution units, configured to execute instructions to perform information processing, including receiving data, generating prompt sentences, invoking models, and storing and retrieving data.

The term “user terminal” refers to an information processing apparatus operated by a user, including but not limited to a personal computer, a mobile communication device, or any other communication device capable of transmitting requirement information to a server over a network.

The term “character information” refers to information expressed as text data, including natural-language sentences, symbols, and numerals, representing requirements, specifications, or other descriptive content.

The term “functional requirements” refers to descriptions, expressed as character information, that specify functions to be provided by a system, including operations, behaviors, and services to be executed by the system.

The term “performance requirements” refers to descriptions, expressed as character information, that specify non-functional characteristics of a system, including response time, throughput, resource usage, and reliability.

The term “prompt sentence” refers to control information expressed as natural-language text or structured text, generated by the processor, and provided as input to a generative information processing model to instruct the model regarding a processing objective, extraction items, or an output format.

The term “generative information processing model” refers to a machine-implemented information processing model configured to generate output information based on input information, including a model that performs natural-language processing, text generation, or structured data generation in response to a prompt sentence.

The term “structured data” refers to data in which elements are organized into a predefined format, including but not limited to tabular data, hierarchical data, or data expressed in a markup or notation language such as a key-value structure.

The term “test case information” refers to information representing a test scenario for verifying a function or behavior of a system, including at least one test identifier, a precondition, input information, operation steps, and an expected result.

The term “normal operation scenario” refers to a test case or a portion of test case information that assumes valid inputs and intended usage conditions under which the system is expected to operate correctly.

The term “abnormal operation scenario” refers to a test case or a portion of test case information that assumes invalid inputs, fault conditions, or exceptional states under which the system is expected to perform error handling or fail-safe behavior.

The term “test identifier” refers to an identification element, including a character string or code, uniquely or distinctively associated with an individual test case within test case information.

The term “precondition” refers to a condition or a set of conditions, such as system state or data state, that is required to be satisfied before execution of a corresponding test case.

The term “input information” refers to data or parameters to be supplied to a system under test when executing a test case, including user inputs, message data, and configuration values.

The term “operation steps” refers to a sequence of actions to be performed during execution of a test case, including user operations, system operations, and invocations of functions or interfaces.

The term “expected result” refers to an outcome, including system state, output data, or observable behavior, that is anticipated when a test case is executed under its precondition with specified input information.

The term “important test point information” refers to information identifying one or more test points that are determined to be significant with respect to quality risk or safety risk, including descriptions of the test points, related test cases, and risk levels.

The term “quality risk” refers to a possibility that a defect or deficiency in a system may adversely affect overall quality attributes, including correctness, reliability, usability, and performance.

The term “safety risk” refers to a possibility that a defect or deficiency in a system may cause harm to persons, property, data, or operational environment, or may lead to hazardous behavior.

The term “defect case information” refers to information representing past defect occurrences, including defect descriptions, conditions under which defects occurred, and associated system components, stored as historical data.

The term “defect pattern information” refers to information representing generalized patterns of defects, including typical causes, manifestations, and conditions that characterize recurring defects across multiple systems or versions.

The term “defect factor information” refers to information identifying potential defect factors that may lead to occurrence of defects in a deployed environment, including related requirements, related test cases, and suspected defect patterns.

The term “potential defect factor” refers to a cause or condition inferred from requirements, test cases, and historical information that may result in a defect if not addressed before deployment.

The term “storage unit” refers to a memory resource or a combination of memory resources, including semiconductor memory, magnetic storage, or other non-transitory storage media, configured to store structured data, test case information, important test point information, and defect factor information.

The term “external apparatus” refers to an information processing apparatus or system different from the server, including a client device, a testing management system, or another server, to which output information is provided.

The term “accumulated defect case information” refers to a collection of defect case information stored over time and maintained in a storage unit for use in analysis, prediction, or model input.

The term “defect pattern” refers to a generalized description of a class of defects having similar causes or behaviors, used as a template or reference for identifying potential defect factors in new requirements or test cases.

The term “output information” refers to information generated by the processor for provision to an external apparatus, including at least one of structured requirement data, test case information, important test point information, and defect factor information.

In one embodiment, a server implements the claimed system as a network-connected information processing apparatus including at least one processor, a main memory, a non-transitory storage device, a network interface, and an input/output interface. The server is connected via a communication network to one or more terminals operated by users. The server executes one or more software modules, including an operating system, a web application framework, an application program for requirement analysis and test generation, and a client library for communicating with a generative AI model. For example, the server uses a general-purpose operating system, a web framework such as a script-based framework or an object-oriented web framework, and an AI client library that provides an API for sending a prompt sentence and receiving generated text from a remote generative AI model. The terminal is an information processing apparatus such as a personal computer or a mobile communication device. The terminal executes a browser or a native application and displays a user interface for inputting requirement text and viewing analysis results. The user operates the terminal to input requirements and specifications as free-form natural-language text, and the terminal transmits the text to the server via a secure communication protocol. The terminal receives structured results, including test case information and important test point information, from the server and displays them in a structured layout such as a list or table format.

The server stores received character information, structured data, test case information, important test point information, and defect factor information in a storage unit. The storage unit is implemented using a relational database system or a document-oriented database system, for example by using a structured query language database. The server defines explicit data structures for these items. For instance, the server represents structured data of requirements as a record including fields such as “function_list,” “input_item_list,” “output_item_list,” “constraint_list,” “business_rule_list,” and “edge_case_list,” each field holding a collection of key-value pairs. The server represents each test case as a record including a test identifier, a precondition, input information, operation steps, an expected result, and an attribute indicating a normal operation scenario or an abnormal operation scenario. The server links records by identifiers so that it can rapidly retrieve all test cases and defect factors related to a particular requirement set.

The server uses a generative AI model as a generative information processing model. In one embodiment, the generative AI model is implemented as a large-scale neural network based on a transformer architecture. The server stores an identifier of the model (for example, a model name and version) and configuration parameters such as a maximum token length, a temperature parameter controlling output randomness, and a top-k or top-p sampling parameter controlling token selection. The generative AI model includes multiple layers of self-attention and feed-forward networks, with learned weight matrices for query, key, and value vectors, and applies positional encoding to input token sequences. The server provides an input sequence composed of a prompt sentence and requirement text, and the model outputs a sequence of tokens that the server decodes to a character string representing structured data or other requested information.

The server configures the generative AI model using training information that includes a corpus of natural-language requirements, annotated test cases, and defect descriptions. The generative AI model is pre-trained on large-scale text data using an unsupervised objective such as a next-token prediction objective. The model parameters are optimized by gradient-based methods such as stochastic gradient descent or adaptive moment estimation, using an error function defined as a cross-entropy loss between predicted token distributions and ground-truth tokens. In a further embodiment, the server or an external training apparatus performs fine-tuning of the generative AI model on domain-specific data including requirement documents and associated test case sets. During fine-tuning, the server adjusts model weights using a lower learning rate and applies regularization techniques such as dropout or weight decay to prevent overfitting. The server may store fine-tuning configuration metadata, including the number of epochs and batch size, in the storage unit.

The server does not merely invoke the generative AI model with static instructions; instead, the server generates different prompt sentences according to the processing phase and the current data state. The server constructs each prompt sentence as a combination of (i) role information indicating the expected role of the model, (ii) processing instructions specifying what information to extract or generate, (iii) constraints on output format, and (iv) contextual data such as requirement text or test cases. The server stores template patterns for prompt sentences and fills variable parts based on current context, thereby implementing a deterministic and reproducible prompt-generation algorithm. This algorithm is not a mere automation of human writing, but is configured to ensure that generated outputs conform to machine-readable structures that the server can parse and validate automatically.

For example, the server may generate the following prompt sentence for requirement analysis:

“You are a software requirements analyst. Analyze the following requirements and extract:
functions,
inputs and outputs,
constraints (performance, security, business rules),
edge cases and exceptional conditions.
Output JSON-like text with the following fields: functions, inputs, outputs, constraints, business_rules, edge_cases.
Requirements:
[REQUIREMENT_TEXT_HERE]”

The server provides this prompt sentence and the requirement text to the generative AI model. The model outputs a structured description of the requirements. The server parses the model output by applying pattern-matching rules and syntax checking. For instance, the server searches for field labels such as “functions:” and “constraints:” and verifies that each field contains a list of items separated by a delimiter. If the server detects a format deviation, the server applies correction logic that uses a secondary parsing rule set or re-prompts the model with an additional instruction such as “Correct the output so that each section starts with the exact field label.” This rule-based correction process is implemented as a deterministic algorithm executed by the processor and improves the robustness of the system.

The server then generates test case information from the structured data by invoking the generative AI model with another prompt sentence. The server may use a prompt such as: “Based on the following analyzed requirements, generate exhaustive test cases including both normal and abnormal scenarios.

For each test case, output: test_id, title, preconditions, input, steps, expected_result, type (normal/abnormal).

### Analyzed Requirements:

[ANALYZED_REQUIREMENTS_HERE]”

The server provides the analyzed requirements as context and obtains a list of test cases. The server assigns unique identifiers to each test case using an internal identifier generation algorithm that constructs identifiers from a project code, a feature code, and a sequence number. The server stores the test cases in the storage unit and builds an index on test identifiers and requirement identifiers in order to accelerate query performance. By structuring the test case data and indexing it, the server reduces search time when filtering or cross-referencing test cases, thereby improving computation efficiency.

The server uses the generated test case information as input data to the generative AI model to identify important test points related to quality and safety. The server generates an additional prompt sentence, for example:

“From the following list of test cases, identify and rank the most important test points that affect quality, safety, and user experience.

Focus on security, data integrity, boundary values, and failure handling.

Output a list with: point_id, description, related_test_ids, risk_level (High/Medium/Low), reason.

### Test Cases:

[TEST_CASES_HERE]”

The server transmits this prompt sentence and the test case list to the generative AI model. The model returns a ranked set of important test points. The server then transforms these into internal data records, computes additional derived fields such as a numeric priority score, and stores them in the storage unit. In one embodiment, the server applies a non-conventional ranking algorithm combining model-assigned risk labels and metadata such as the number of related test cases and the severity category of affected functions. This algorithm uses a weighted sum of features (for example, risk_level_weight, function_criticality_weight, and coverage_weight) and normalizes scores across all test points to facilitate comparison. This structured combination of model output and deterministic ranking improves the uniformity and reproducibility of risk prioritization beyond manual human judgment.

The server further identifies potential defect factors by generating another prompt sentence that instructs the generative AI model to reference not only current structured data, test cases, and important test points, but also accumulated defect case information and defect pattern information. An example of such a prompt is:
“Given the following analyzed requirements, test cases, important test points, and known defect patterns, infer potential defect factors that may cause defects after deployment. For each factor, output: factor_id, description, related_requirement, related_test_cases, suspected_pattern, recommended_additional tests.

### Analyzed Requirements:

[ANALYZED_REQUIREMENTS_HERE]

### Test Cases:

[TEST_CASES_HERE]

### Important Test Points:

[IMPORTANT_POINTS_HERE]

### Known Defect Patterns:

[DEFECT PATTERNS_HERE]”

The server aggregates the corresponding data from the storage unit and embeds it in the prompt context. The generative AI model returns defect factor descriptions. The server parses these descriptions, associates them with requirement identifiers and test case identifiers, and stores them as defect factor information. The server may also compute a defect likelihood score by correlating the inferred defect pattern with statistical frequencies of historical defects stored in the storage unit. This scoring process uses explicitly coded rules such as mapping each known pattern to a base risk value and adjusting that value based on the number of related test cases and the presence of critical components. This hybrid process, which combines generative reasoning with deterministic feature-based scoring, results in improved prediction accuracy and reduces false positives relative to simple keyword-based methods.

The server offers multiple usage scenarios in which the combined artifacts (structured requirements, test cases, important test points, defect factors) are utilized to control external systems and to improve the technical operation of those systems. In one embodiment, the server integrates with an automated test execution apparatus via an application programming interface. The server sends selected test cases and important test points to a test execution controller. The controller then configures test scripts or robot-based user interface actions according to the provided test identifiers and operation steps, and directly controls testing hardware such as instrumented devices under test or emulated environments. In this embodiment, the improved test case coverage and risk-based prioritization achieved by the server directly enhance the efficiency and reliability of automated testing, thereby improving the technical performance of hardware and software verification.

In another embodiment, the server provides output information to a continuous integration system. The server selects a subset of high-risk test cases based on important test point information and defect factor information and transmits them as a prioritized test suite. The continuous integration system schedules these tests more frequently during code integration cycles, thereby reducing computational resource consumption as compared to executing all possible test cases. Because the server computes prioritization based on structural requirement analysis and statistical defect pattern matching, the selection is more targeted than a human-designed subset, enabling reduction of processing load and shortening of test execution time without a proportional reduction in test effectiveness.

The system provides technical advantages that go beyond mere automation of human decision making. The server transforms unstructured requirement text into structured, indexed, and cross-linked data artifacts by orchestrating a specialized prompt-driven interaction with a generative AI model and by applying deterministic post-processing, validation, and ranking algorithms. This configuration improves the internal operation of the computer by reducing memory fragmentation through standardized data structures, by enabling more efficient query planning via indexing, and by decreasing communication volume with the generative AI service through reuse of intermediate structured representations. For example, once the server has generated structured requirement data, the server does not resend the original large requirement text for subsequent prompt sentences; instead, the server sends compact summaries or identifiers, thereby lowering network bandwidth usage and latency.

Moreover, the generative AI model is not used as a generic text generator but as a component specialized through prompt engineering and fine-tuning to the tasks of requirement structuring, test case generation, and defect factor inference. The server's algorithm for constructing prompt sentences enforces output schemas that align with internal data structures, which allows automatic machine parsing without manual human interpretation. This explicit alignment between model prompts and computer-readable structures yields improved parsing accuracy and reduces error handling overhead, which directly enhances processing speed and stability of the system.

In further embodiments, the server can vary model parameters and prompt formats adaptively based on monitored performance metrics. For instance, the server may detect that test case generation for a particular project yields redundant scenarios and, in response, adjust temperature settings or add negative examples to the prompt sentence to suppress duplication. The server may store historical relationships between prompt content, model configuration, and output quality, and then use this history to select a near-optimal configuration for new projects. This closed-loop optimization process constitutes a technical improvement in how the server configures the generative AI model and reduces the number of interactions required to obtain acceptable outputs, thereby lowering total computational and communication costs.

Alternative embodiments are also possible. The server may execute a locally deployed generative AI model instead of, or in addition to, a remote model accessed through a network. In such a case, the server stores the neural network weights in local storage and performs inference directly on its processor using hardware acceleration such as a graphics processing unit. The server may partition the model into encoder and decoder components and execute only the encoder locally for requirement structuring, while offloading decoding for long-form text generation to an external resource. In another embodiment, the server combines generative model output with a rule-based reasoning engine that applies domain-specific constraints encoded as logical rules, thereby further refining structured data, test cases, or defect factor information.

The described embodiments demonstrate that the system is implemented as a concrete arrangement of hardware and software modules, data structures, and algorithms that modify the operation of the computer to perform requirement analysis and test design with improved speed, accuracy, and resource efficiency. The server, the terminal, and the user cooperate through specific data flows and prompt-driven interactions, and the generative AI model is exploited in a structured and controlled manner to improve the underlying computer technology rather than merely automating human reasoning.

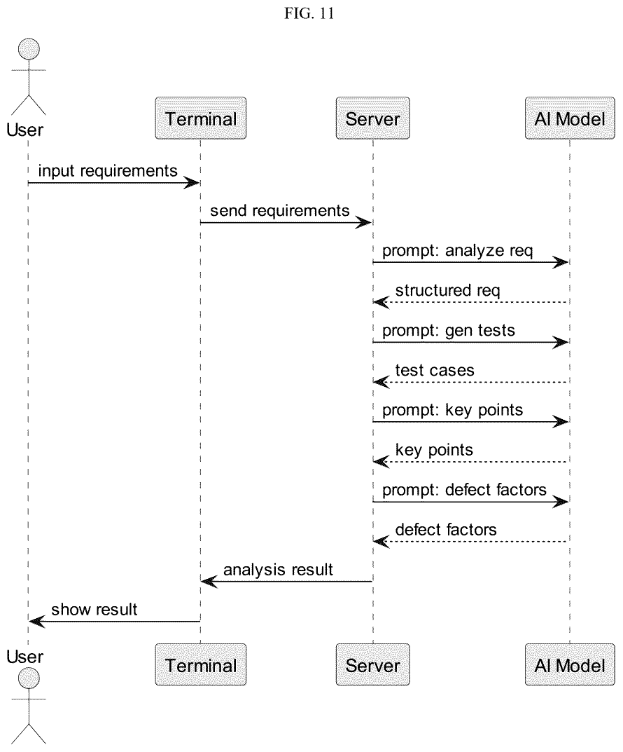

The following describes the processing flow using FIG. 11.

### Step 1

The user prepares requirement and specification text describing new or modified system functions.

The user operates the terminal to enter this text into an input field or to upload a text file

The terminal receives the user input as character information and converts it into a request data structure including fields such as project identifier, language, and raw requirement text.

The terminal outputs this structured request and transmits it to the server via a network using a communication protocol.

### Step 2

The server receives the request from the terminal through a network interface and a web application framework.

The server parses the incoming request to extract the raw requirement text and associated metadata such as project identifier and user identifier.

The server validates that the requirement text is present and within allowable size limits, and the server rejects or logs malformed requests.

The server outputs validated requirement text and metadata and stores them in a storage unit as initial records for subsequent processing.

### Step 3

The server generates a first prompt sentence for requirement analysis based on the validated requirement text.

The server constructs the prompt sentence by combining a fixed instruction template with the actual requirement text, thereby defining extraction items (functions, inputs, outputs, constraints, business rules, edge cases) and an expected output format.

The server uses the requirement text and the prompt template as input and performs string concatenation and token length estimation as data operations to generate a complete prompt sentence suitable for the generative AI model.

The server outputs the constructed prompt sentence as model input data.

### Step 4

The server sends the first prompt sentence, together with the requirement text if needed, to the generative AI model via an AI client library.

The server provides configuration parameters (such as model identifier, temperature, and maximum token length) to control the generative AI model's behavior.

The generative AI model processes the input and returns generated text that represents structured requirement data.

The server receives this generated text as an output sequence from the model and passes it to a parser module.

### Step 5

The server parses the generated text to produce structured data representing analyzed requirements.

The server uses pattern-matching rules and syntax validation to detect field labels (such as “functions”, “inputs”, “outputs”, “constraints”, “business_rules”, “edge_cases”) and to separate each section into lists of items.

The server uses the model output text as input and performs tokenization, string search, and splitting operations to build an internal data structure, such as a dictionary or record, for each field.

The server outputs structured requirement data and stores this data in the storage unit, linked to the project identifier and requirement identifier.

### Step 6

The server generates a second prompt sentence for test case generation using the structured requirement data as input.

The server formats the structured requirement data into a compressed textual description and embeds this description into a test-generation instruction template.

The server specifies in the prompt sentence that the generative AI model should output a set of test cases, each including test identifier, title, preconditions, input, steps, expected result, and type (normal or abnormal).

The server outputs this second prompt sentence as input to the generative AI model.

### Step 7

The server sends the second prompt sentence and the structured requirement context to the generative AI model via the AI client library.

The generative AI model returns generated text representing multiple test cases.

The server receives this text and uses it as input to a test case parsing module.

The server outputs intermediate test case text for further processing.

### Step 8

The server parses the intermediate test case text to produce machine-readable test case information.

The server detects individual test case blocks by delimiters or explicit field labels and extracts each test identifier, title, preconditions, input, steps, expected result, and type.

The server uses the generated text as input and performs string segmentation, key-value parsing, and normalization of field names to build a list of test case records.

The server outputs a normalized test case list and assigns unique identifiers to each test case, then stores the list in the storage unit associated with the corresponding requirement identifier.

### Step 9

The server generates a third prompt sentence to extract important test points based on the stored test case information.

The server aggregates selected test case fields (such as titles, preconditions, inputs, and expected results) into a compact representation and embeds this representation into a risk-focused instruction template.

The server specifies in the prompt sentence that the generative AI model should identify and rank test points affecting quality and safety, and should output for each test point a description, related test identifiers, risk level, and reason.

The server outputs the third prompt sentence together with the summarized test case information as model input.

### Step 10

The server sends the third prompt sentence and the summarized test case information to the generative AI model.

The generative AI model generates text describing important test points and their rankings.

The server receives this generated text and treats it as input to an important-point parsing module.

The server outputs the raw important test point text for structured conversion.

### Step 11

The server parses the raw important test point text to extract important test point information.

The server uses pattern-matching logic to detect point identifiers, descriptions, lists of related test identifiers, risk levels, and reasons, and converts these elements into structured records.

The server uses the model output as input and performs mapping from textual risk levels (such as “High”, “Medium”, “Low”) to numeric scores, thereby computing a priority value for each test point.

The server outputs a structured list of important test points and stores this list in the storage unit linked to test case identifiers and requirement identifiers.

### Step 12

The server retrieves accumulated defect case information and defect pattern information from the storage unit and combines them with the structured requirements, test cases, and important test points as input for defect factor inference.

The server generates a fourth prompt sentence that instructs the generative AI model to infer potential defect factors based on these combined data sources.

The server embeds summaries or subsets of these data into the prompt sentence, specifying that the output should include a factor identifier, description, related requirements, related test cases, suspected pattern, and recommended additional tests for each potential defect factor.

The server outputs the fourth prompt sentence and the aggregated contextual data as input to the generative AI model.

### Step 13

The server sends the fourth prompt sentence and the aggregated contextual data to the generative AI model.

The generative AI model generates descriptive text identifying potential defect factors and their relationships to requirements and tests.

The server receives this generated text and provides it as input to a defect factor parsing module.

The server outputs the raw defect factor text to be structured into machine-readable form.

### Step 14

The server parses the raw defect factor text to produce structured defect factor information.

The server applies parsing rules to detect factor identifiers, textual descriptions, references to requirement identifiers and test identifiers, and mentions of defect patterns and recommended tests.

The server uses the model output as input and performs extraction, normalization of identifier formats, and cross-checking against existing requirement and test case records to ensure consistency of references.

The server outputs a list of structured defect factor records and stores them in the storage unit with links to the corresponding requirements and test cases.

### Step 15

The server compiles a comprehensive analysis result for a given project or requirement set based on the stored structured data, test case information, important test point information, and defect factor information.

The server retrieves related records from the storage unit and merges them into a hierarchical or relational representation, grouping test cases and defect factors under their associated requirements.

The server uses these records as input and performs data aggregation, sorting by risk level or priority scores, and formatting into a response structure suitable for transmission. The server outputs a consolidated analysis response and sends it to the terminal via the network.

### Step 16

The terminal receives the consolidated analysis response from the server.

The terminal parses the response data to extract lists of requirements, test cases, important test points, and defect factors.

The terminal uses this parsed data as input and performs rendering operations, such as generating tables, highlight markers for high-risk items, and links between test cases and defect factors on a display screen.

The terminal outputs a visual representation of the analysis, allowing the user to review coverage, risks, and potential defects.

### Step 17

The user reviews the displayed analysis on the terminal and identifies portions of the requirements or test cases that should be modified or clarified.

The user edits the requirement text or adds comments and additional constraints through input components provided by the terminal.

The terminal uses the user's modifications as input and constructs an update request that includes references to existing requirement identifiers and changed text segments.

The terminal outputs this update request and transmits it to the server, enabling iterative refinement of the analysis by repeating relevant steps in the processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional test automation for control programs of industrial equipment, such as factory automation devices, relies heavily on manually designed test cases, manually crafted test scripts, and ad hoc analysis of test results. In many systems, a processor merely executes static test suites defined in advance by engineers, without systematically leveraging machine learning or generative artificial intelligence to refine test coverage or to infer latent defect patterns. As a result, when new functions are introduced into control software, the testing performed before deployment is often incomplete, leading to defects that manifest only under rare or complex operating conditions. These defects can cause production stoppages, quality degradation, and safety risks in operational environments.

From a computer-technology standpoint, existing systems treat requirement data, test case data, and test result data as loosely coupled artifacts that are not integrated into a unified, machine-processable loop. In many architectures, the processor does not transform human-readable requirements into structured data suitable for automated reasoning, does not generate formally structured prompt sentences for interaction with a generative AI model, and does not automatically translate AI-generated content into executable test scripts for real devices or simulation environments. Furthermore, test result analysis is frequently performed by human operators using general-purpose visualization tools, without a standardized mechanism for converting high-volume time-series data and status data into compact analysis input suitable for automated defect-factor extraction.

Because of these limitations, the computing processes performed by the server are suboptimal in several respects: (i) they do not efficiently generate comprehensive, requirement-driven test suites; (ii) they do not adaptively update test content based on observed behavior; and (iii) they do not provide a systematic, repeatable pipeline in which a processor cooperates with a generative AI model via precisely structured prompt sentences to iteratively improve test coverage and to reduce the probability of operational failures. This leads to increased engineering cost, longer release cycles for new functions, and persistent residual risk of latent defects.

Accordingly, there is a need for an improved computer-implemented technique in which a processor converts user-specified functional requirements and performance specifications into structured data, generates context-rich prompt sentences for a generative AI model, receives and structures AI-generated test case information, automatically constructs and executes test scripts on target apparatuses or simulation environments, and generates analysis input data from test results to drive further AI-based analysis of potential fault factors and improvement proposals. By establishing such an integrated, machine-orchestrated loop, the underlying computer system can more effectively automate test design, test execution, and defect analysis, and thereby improve the reliability and efficiency of control software deployment.

The specific processing by the specific processing unit 290 of the data processing device 12 in Application Example 1 is realized by the following means.

The present invention provides a server comprising a processor configured to receive, from a user via a client device, functional requirements and performance specifications for a controlled apparatus, convert the functional requirements and the performance specifications into structured machine-readable data, generate, based on the structured data, a first prompt sentence that instructs a generative AI model to analyze the functional requirements and the performance specifications, and transmit the first prompt sentence to the generative AI model; the processor is further configured to receive, from the generative AI model, an analysis result, generate test case information based on the analysis result, the test case information including, for each test case, input conditions, expected behavior, and pass/fail determination conditions, and generate executable test scripts for the controlled apparatus or for a simulation environment that simulates the controlled apparatus based on the test case information; the processor is further configured to execute the test scripts on the controlled apparatus or the simulation environment, acquire test result data including operation signals, state quantities, and time-series data, generate, based on the test result data, analysis input data including summary information and abnormality occurrence information, generate a second prompt sentence that instructs the generative AI model to extract potential fault factors and propose improvements based on the analysis input data, and transmit the analysis input data together with the second prompt sentence to the generative AI model; and the processor is further configured to receive, from the generative AI model, an analysis result regarding the potential fault factors and the improvement proposals, and generate report information including the functional requirements, the test case information, the test result data, and the analysis result. This enables the computer system to implement an integrated and iterative test automation loop in which structured requirement data, AI-generated test case data, and machine-collected test result data are transformed and exchanged through prompt sentences with a generative AI model, thereby improving the technical performance of the server in generating, executing, and analyzing tests, reducing residual defects at deployment, and enhancing the reliability and efficiency of control software operation.

The term “processor” refers to a hardware computation element, such as a central processing unit or an execution core, that executes program instructions to perform the functions described herein.

The term “terminal” refers to any user-operated information processing device, such as a personal computer, a tablet device, or a mobile communication device, that provides a user interface for inputting information and receiving outputs from the system. The term “user” refers to a human operator who interacts with the system through the terminal to input functional requirements and performance specifications and to review reports and analysis results.

The term “functional requirements” refers to information that specifies functions to be performed by a controlled apparatus or a software component, including behaviors, operations, and conditions to be satisfied.

The term “performance specifications” refers to quantitative or qualitative constraints relating to performance of a controlled apparatus or a software component, including limits on load, speed, timing, accuracy, safety margins, and similar metrics.

The term “structured data” refers to data organized according to a predefined format or schema, such as a key-value representation, table, or hierarchical structure, which is machine-readable and suitable for programmatic processing by the processor.

The term “prompt sentence” refers to a machine-generated natural-language expression or a set of natural-language expressions that instruct a generative AI model to execute a designated analysis, prediction, or generation task based on provided context or data.

The term “generative AI model” refers to a machine learning model that generates text, structured data, or other output in response to an input prompt sentence, and that is trained using data-driven techniques such as neural network-based learning.

The term “analysis result” refers to information output from the generative AI model in response to a prompt sentence, the information including interpretations, derived relationships, recommended test cases, potential fault factors, or proposed improvements. The term “test case information” refers to data describing a test case, including at least input conditions, expected behavior of a controlled apparatus or software component, and pass/fail determination conditions.

The term “input conditions” refers to values, states, or environmental settings applied to a controlled apparatus, a software component, or a simulation environment during execution of a test case.

The term “expected behavior” refers to a description of outputs, states, or temporal responses that a controlled apparatus or a software component is intended to exhibit under specified input conditions during a test case.

The term “pass/fail determination conditions” refers to criteria used to judge whether observed behavior during a test case conforms to the expected behavior, including thresholds, tolerances, logical conditions, or timing limits.

The term “test script” refers to a sequence of machine-executable instructions or commands generated from test case information, the sequence being configured to control a controlled apparatus or a simulation environment to perform a test case.

The term “controlled apparatus” refers to a physical device or a set of devices that execute control operations according to a control program, including, for example, industrial machinery, automation equipment, or motion control systems.

The term “simulation environment” refers to a software-implemented or hardware-implemented environment that emulates behavior of a controlled apparatus, enabling execution of test scripts without operating the actual physical device.

The term “test result data” refers to data collected during execution of a test script, including operation signals, state quantities, time-series measurements, error codes, and other observed values.

The term “operation signals” refers to signals representing control commands, actuator states, sensor outputs, or status flags generated or observed during operation of a controlled apparatus or a simulation environment.

The term “state quantities” refers to measurable or computable variables that represent an internal or external state of a controlled apparatus or a simulation environment, such as position, velocity, acceleration, temperature, or load.

The term “time-series data” refers to measurements or state values that are recorded together with associated time information, enabling analysis of temporal behavior during test execution.

The term “analysis input data” refers to data derived from test result data, including summary information, abnormality occurrence information, and other condensed representations configured for input to a generative AI model for further analysis.

The term “summary information” refers to condensed data derived from raw test result data, such as aggregated metrics, representative values, statistical indicators, or lists of noteworthy events.

The term “abnormality occurrence information” refers to information indicating occurrence of behavior deviating from expected behavior during test execution, including detected errors, threshold violations, alarms, or unsafe conditions.

The term “potential fault factors” refers to candidate causes or contributing conditions inferred as likely to lead to faults, defects, or failures in a controlled apparatus or a software component.

The term “improvement proposals” refers to recommendations or suggested modifications, such as parameter adjustments, logic changes, or test coverage enhancements, that are intended to reduce or eliminate potential fault factors.

The term “report information” refers to output data generated for presentation to a user, the output data including functional requirements, test case information, test result data, analysis input data, and analysis results provided by the generative AI model.

In one embodiment, a server implements the claimed system as a network-accessible test automation platform for control software of industrial equipment. The server includes at least one hardware processor, a main memory, a non-volatile storage device, a network interface controller, and an operating system such as a general-purpose server operating system. The server executes application software implemented, for example, in a high-level programming language running on a runtime environment. The server communicates with one or more terminals over a communication network using standard network protocols.

A terminal operates as a client device that provides a graphical user interface. The terminal may be a personal computer, a tablet, or a handheld device, and may execute a web browser or a dedicated application. The terminal transmits user inputs to the server and displays result information received from the server. A user operates the terminal to define functional requirements and performance specifications of a controlled apparatus, review generated test cases, and inspect test results and analysis reports.

The server maintains one or more data stores on the non-volatile storage device. These data stores include a requirement repository for structured requirement data, a test case repository for structured test case information, a test result repository for time-series operational data, and a model-interaction log repository for recorded prompt sentences and responses exchanged with a generative AI model. The server represents the structured data using predefined schemas, for example, hierarchical object structures with fields for identifiers, numerical parameters, textual descriptions, and status flags. The server uses in-memory representations of these data structures within application modules to support efficient access and transformation during processing.

The server uses a generative AI model deployed on a computing platform that is accessible over the network via an application programming interface. In one implementation, the generative AI model is a transformer-based neural network that accepts tokenized natural-language input and generates tokenized natural-language output. The model includes an embedding layer that converts word or subword tokens into dense vectors, a plurality of self-attention layers that compute context-dependent representations using multi-head attention, feedforward layers with non-linear activation functions such as rectified linear units or Gaussian error linear units, and a final output layer that produces a probability distribution over a vocabulary. The generative AI model is trained offline using supervised learning and reinforcement learning from human feedback on corpora that include technical documentation, test specifications, and control-system descriptions.

The server encodes each prompt sentence for the generative AI model as a sequence of text tokens. The server includes, in the prompt sentence, structured instructions about required output formats and evaluation criteria, thereby constraining the generative AI model to output machine-parseable content rather than arbitrary free text. For example, the server generates a prompt sentence of the following form:
“You are a test engineer for an industrial control program. The new conveying operation has the following requirements: maximum load 10 kilograms, conveying speed 1 meter per second, allowable positioning error plus or minus 2 millimeters, emergency stop time within 200 milliseconds. Based on these requirements, generate detailed test cases for normal, boundary, and abnormal conditions. For each test case, output: test identifier, preconditions, input parameters, expected behavior, and pass or fail criteria.”

In another example, the server generates a prompt sentence for analysis of test results of the following form:
“You are an expert in industrial motion control. We executed a set of test cases for a conveying function. Several tests failed with position overshoot up to 4 millimeters and emergency stop delay up to 280 milliseconds. The following summary describes the failed cases, including input loads, speeds, deceleration profiles, and measured stop times. Analyze the summary and identify likely fault factors in control logic or parameter settings, explain under which conditions each fault is likely to occur, and propose specific modifications to prevent recurrence.”

By embedding these explicit instructions and constraints, the server establishes a non-conventional interaction pattern with the generative AI model. This pattern restricts the generative AI model to produce outputs that can be parsed into a pre-defined internal schema, which improves determinism and reduces parsing errors. The server thus transforms unstructured model outputs into structured test case information and structured analysis information that are directly usable by downstream modules.

The server stores training-related metadata for the generative AI model, such as model architecture parameters (number of layers, number of attention heads, hidden dimension size), training objective (cross-entropy loss over next-token prediction), learning rate schedule, and regularization hyperparameters. While the main training is performed offline, the server can perform domain adaptation by fine-tuning the model on a curated dataset composed of historical requirements, expert-written test cases, and labeled defect analyses. The server weights training examples with importance scores to bias the model toward industrial control-related content. The server uses mini-batch stochastic gradient descent with backpropagation through time to adjust model weights, and may apply data augmentation techniques such as paraphrasing of requirements and synthetic generation of boundary-condition cases to increase the coverage of rare scenarios.

When interacting with the generative AI model at inference time, the server configures decoding parameters such as temperature, top-k sampling, and maximum output length. The server may adjust these parameters adaptively based on the complexity of the requirements; for example, the server reduces the temperature and restricts allowed tokens to enforce more deterministic outputs when generating test case schemas, while allowing a slightly higher temperature for defect explanation prompts to capture diverse hypotheses.

The server processes requirement data received from the terminal using a requirement-normalization module. This module maps user-entered natural-language descriptions and numerical values into a canonical internal representation. For example, the server converts units (kilograms, meters per second, milliseconds) into standard units, enforces numeric ranges, and attaches semantic tags such as “load_limit”, “speed_setpoint”, and “stop_time_constraint”. The server uses rule-based parsing and pattern-matching algorithms to separate constraint expressions, operational modes, and safety conditions. This normalization enables the server to generate prompt sentences that include consistent terminology and numeric formats, improving the generative AI model's understanding and reducing misinterpretation.

The server includes a prompt-construction module configured to generate prompt sentences from normalized requirement data. The prompt-construction module concatenates role descriptions, requirement summaries, constraints on output format, and examples when needed. For example, the module can embed one or more few-shot examples of simple test cases in the prompt to influence the generative AI model's output format. The use of systematic, machine-generated prompt sentences differs from manual prompt crafting by human engineers and enables the server to guarantee structural consistency and coverage of all relevant requirement fields.

The server includes a response-parsing module that consumes the generative AI model's output. The server does not treat the output as opaque text; instead, the server applies a combination of deterministic parsers, such as line-based delimiters and key markers, and fallback pattern-matching algorithms to extract fields like test identifiers, parameter names, parameter values, expected states, and pass or fail criteria. The server stores the extracted data in structured test case objects in the test case repository. This explicit mapping from textual output to internal data structures is an important technical component that enables reliable and repeatable use of a generative AI model within an automated pipeline.

The server generates executable test scripts from the structured test case information. In one embodiment, the server maps each high-level input condition (for example, “conveying speed equals 1 meter per second, load equals 10.1 kilograms”) to low-level commands appropriate for a specific controller interface. The server may use a library of command templates corresponding to a particular industrial communication protocol. The server assembles commands into a script file and annotates each command with timing constraints and assertion checks. Assertions express pass or fail criteria such as “final position error less than or equal to 2 millimeters” or “emergency stop completed within 200 milliseconds”. The server stores each script in the test case repository and associates it with a script identifier.

The server interfaces with either an actual controlled apparatus or a simulation environment. The simulation environment may be a software-based plant model running on the server or on another machine, which computes dynamic responses of motors, conveyors, and sensors in response to command inputs using numerical integration algorithms and control system equations. The server transmits commands from the test script to the controlled apparatus or simulator at precise time intervals and collects response data including encoder positions, velocities, load sensor readings, and alarm signals. The server timestamps each collected data sample with high-resolution clock values to form time-series logs.

The server compresses the raw time-series and event logs into analysis input data. The server calculates derived features such as maximum overshoot, settling time, integral of absolute error, and frequency of alarm occurrences. The server aggregates these features across repetitions and test cases to produce summary metrics. The server flags test segments where constraints were violated and includes indicators representing the severity and duration of each violation. The resulting analysis input data is represented as structured records with fields for test identifiers, feature vectors, violation flags, and textual annotations.

The server uses an analysis-prompt-construction module to generate a second class of prompt sentences tailored for test-result analysis. The module includes, in each analysis prompt, selected features and summary metrics in a compact form, together with instructions that specify analysis tasks such as root-cause identification, risk ranking, and proposal of parameter adjustments. This explicit feature selection and summarization ensures that the generative AI model receives a well-defined subset of data rather than unfiltered logs, which improves computational efficiency, reduces communication overhead, and focuses the model's attention on technically relevant aspects.

The generative AI model processes the analysis prompts by computing, layer-by-layer, contextualized token embeddings that incorporate both requirement context and numerical summaries. Because the analysis input data includes structured patterns of failures and features not easily tractable by manual inspection, the model can detect correlations such as “constraint violations occur primarily when load exceeds 80 percent of the specified limit and deceleration is below a threshold value.” The server receives the model's textual analysis and maps sentences to structured “potential fault factor” records, each including a description, an associated condition, a suggested change (for example, “increase deceleration parameter by 20 percent when load exceeds 8 kilograms”), and an estimated risk level.

The server then assembles a comprehensive report that combines all relevant information: original functional requirements, generated test cases, executed test scripts, observed test results, computed features, and AI-generated analysis. The server converts this information into a format suitable for display on the terminal, such as a web-based dashboard or a downloadable document. The terminal presents the report in a way that enables the user to navigate by requirement, by test case, or by potential fault factor. The user can use this information to revise control logic, tune parameters, or modify safety conditions in the control program.

This configuration improves computer technology in several ways. First, the server increases processing speed and coverage by automatically converting high-level requirement data into machine-readable structures, generating prompt sentences in a standardized format, and invoking a generative AI model to synthesize test case information that would be extremely time-consuming to craft manually. Because the server implements deterministic parsing and mapping from natural-language output into precise test script commands, it eliminates repetitive human editing steps and reduces human error in translating specifications into executable tests.

Second, the server improves precision and reduces residual defects by using rich, derived features in the analysis input data, rather than merely relying on pass or fail labels. By computing advanced metrics such as overshoot, settling time, and constraint violation durations, and by providing these metrics to the generative AI model in structured form, the system achieves finer-grained defect characterization than simple threshold-based rule systems. The generative AI model's architecture, with multiple self-attention layers, can capture long-range dependencies between requirement constraints, control parameters, and observed behavior that traditional rule-based or statistical methods may overlook.

Third, the server optimizes data management and communication efficiency. The use of structured internal representations for requirements, test cases, and test results, and the extraction of compact summaries for analysis prompts, reduces the amount of data transmitted to the generative AI model and stored in long-term repositories. The system avoids redundant logging of irrelevant information by focusing on features associated with constraints and safety margins. This leads to improved computation efficiency on both the server and the model-hosting platform.

Fourth, the server applies non-conventional, AI-driven rules and workflows to test design and evaluation. Instead of following fixed test templates, the system uses the generative AI model to infer additional boundary and abnormal scenarios based on patterns learned from training data. For example, when the model detects that combination of high load and rapid acceleration is a frequent source of problems in historical data, it proposes test cases that specifically stress such combinations, even if the user has not explicitly described them. This behavior is not a mere automation of human routines but constitutes a new computational capability that expands test coverage in systematically data-informed directions.

Alternative embodiments can vary in hardware and software implementations while preserving the core data structures and processing flow. The server may employ different operating systems or programming frameworks, and the generative AI model may be hosted on a separate cloud infrastructure or integrated as an on-premises accelerator. The simulation environment may be implemented as a physics-based numerical simulation, a hardware-in-the-loop configuration with real controllers and simulated sensors, or a combination thereof. The internal schemas for requirements, test cases, and analysis features may be extended to accommodate additional types of controlled apparatuses, such as robotic arms, process control loops, or transportation systems.

In each embodiment, the essential structure remains that the server converts user requirements into structured data, constructs and transmits well-defined prompt sentences to a generative AI model, parses and structures the model's responses, generates and executes test scripts on real or simulated hardware, transforms raw test results into feature-based analysis input data, and uses additional prompt sentences to guide the generative AI model in extracting potential fault factors and proposing improvements. Because these operations are implemented as concrete data transformations and algorithmic procedures within a computing infrastructure, and because they are applied to the technical problem of verifying and improving control software behavior of real-world apparatuses, the system does not merely perform generic abstract processing but provides specific improvements in computational test generation, execution, and analysis.

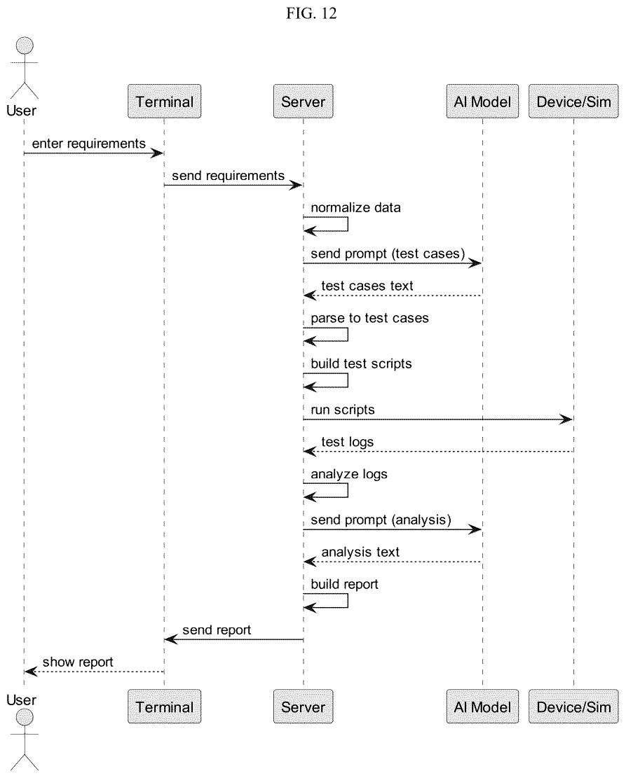

The following describes the processing flow using FIG. 12.

### Step 1

The user operates the terminal to input functional requirements and performance specifications for a controlled apparatus. The input includes, for example, a textual description of a new conveying function, numerical limits such as maximum load, permitted speed, allowable positioning error, and timing constraints such as maximum emergency stop time. The terminal packages these inputs into a structured request, for example as a JSON document, and transmits the request to the server via a network interface using a communication protocol. The input of this step is user-entered requirement and specification data, and the output is a formatted request message sent from the terminal to the server.

### Step 2

The server receives the request from the terminal and parses the message into internal data structures. The server validates data types and ranges, converts units to standard units, and assigns semantic labels to each parameter, such as load_limit, speed_setpoint, and stop_time_constraint. The server performs data processing that includes syntax checking, numeric range checking, and normalization of textual descriptions. The input of this step is the formatted request message, and the output is normalized requirement data stored in memory and optionally persisted in a requirement repository.

### Step 3

The server constructs a first prompt sentence for a generative AI model based on the normalized requirement data. The server reads each requirement field, converts numeric values into human-readable text, and inserts these values into a template that defines the role of the model, the task description, and the expected output format. The server may, for example, generate a prompt sentence such as: “You are a test engineer for an industrial control program. The new conveying operation has the following requirements: maximum load 10 kilograms, conveying speed 1 meter per second, allowable positioning error plus or minus 2 millimeters, emergency stop time within 200 milliseconds. Based on these requirements, generate detailed test cases for normal, boundary, and abnormal conditions. For each test case, output: test identifier, preconditions, input parameters, expected behavior, and pass or fail criteria.” The server concatenates these textual segments and encodes them as a character or token sequence. The input of this step is the normalized requirement data, and the output is the first prompt sentence ready to be sent to the generative AI model.

### Step 4

The server invokes the generative AI model with the first prompt sentence. The server transmits the prompt sentence, together with configuration parameters such as temperature, maximum token length, and desired response style, to the model endpoint via a network interface. The server waits for the model's response, which consists of one or more text segments containing proposed test cases. The primary data processing here is network serialization of the prompt sentence and reception of the model's textual output. The input of this step is the first prompt sentence, and the output is raw textual content representing AI-generated test case descriptions.

### Step 5

The server parses the raw textual content from the generative AI model into structured test case information. The server applies pattern-matching rules, delimiters, and keyword detection to identify boundaries between test cases and to extract fields such as test identifier, preconditions, input parameters, expected behavior, and pass or fail criteria. The server converts literal values in the text (for example, “10 kilograms”) into normalized numeric fields tagged with units and types. The data processing includes tokenization of the text, recognition of field labels, conversion of strings to typed values, and construction of internal objects representing each test case. The input of this step is the raw textual response from the generative AI model, and the output is structured test case information stored in the test case repository.

### Step 6

The server generates executable test scripts from the structured test case information. The server maps each high-level input parameter in a test case (such as load, speed, acceleration, and emergency stop trigger) to low-level control commands defined by the communication protocol of the controlled apparatus or the simulation environment. The server sequences these commands in time, inserts necessary setup and teardown actions, and embeds assertion checks that compare observed values with expected behavior described in the test case. The server writes the resulting sequences as script files or as records in a script table and assigns identifiers to each script. The data processing includes rule-based translation from abstract test case fields into concrete command sequences and assertion definitions. The input of this step is the structured test case information, and the output is a set of executable test scripts linked to corresponding test cases.

### Step 7

The server executes the generated test scripts on a controlled apparatus or on a simulation environment. The server loads a selected script, establishes a communication session with the apparatus or simulator, and sends control commands at scheduled times according to the script content. The server receives sensor readings, status flags, and feedback signals from the apparatus or simulator during execution and records these values along with precise timestamps. The server may repeat tests multiple times or under different environmental conditions as specified in the test case information. The data processing at this step includes command scheduling, real-time data acquisition, and initial buffering of measurement data. The input of this step is the set of executable test scripts, and the output is raw test result data in the form of time-stamped operation signals and state quantities.

### Step 8

The server processes the raw test result data to generate summarized test outcomes and feature vectors. The server segments the time-series data by test case and by phase of operation, computes metrics such as maximum overshoot, steady-state error, response time, and duration of any constraint violations, and evaluates the pass or fail determination conditions defined in each test case. The server marks each test as passed or failed and records any violations with associated metrics. The server then constructs analysis input data that includes, for each test case, identifiers, computed metrics, pass or fail status, and descriptions of abnormal behavior. The data processing involves numerical calculations over time-series data, comparison of values to thresholds, and aggregation of features into compact structures. The input of this step is the raw test result data, and the output is structured analysis input data and updated test status records.

### Step 9

The server constructs a second prompt sentence to request defect-factor analysis from the generative AI model. The server selects relevant fields from the analysis input data, such as lists of failed test cases, associated metrics, and descriptions of constraints violated. The server formats this information in natural language and embeds it into a template that describes the analysis task. For example, the server may generate a prompt sentence such as: “You are an expert in industrial motion control. We executed a set of test cases for a conveying function. Several tests failed with position overshoot up to 4 millimeters and emergency stop delay up to 280 milliseconds. The following summary describes the failed cases, including input loads, speeds, deceleration profiles, and measured stop times. Analyze the summary and identify likely fault factors in control logic or parameter settings, explain under which conditions each fault is likely to occur, and propose specific modifications to prevent recurrence.” The data processing includes selection, summarization, and textual formatting of the analysis input data. The input of this step is the structured analysis input data, and the output is the second prompt sentence prepared for transmission to the generative AI model.

### Step 10

The server transmits the second prompt sentence and the associated analysis input data to the generative AI model and receives an analysis response. The server serializes the prompt and embedded summaries into a request, sends the request via the network, and obtains a textual response containing identified potential fault factors, associated conditions, and proposed improvements. The data processing here involves network communication and reception of the analysis text. The input of this step is the second prompt sentence together with the analysis input data, and the output is a textual analysis result from the generative AI model.

### Step 11

The server parses the analysis result into structured records representing potential fault factors and improvement proposals. The server identifies segments in the text that correspond to specific causes, affected conditions, and recommended changes, and maps these segments into fields such as description, affected parameter, recommended adjustment, and severity ranking. The server links each fault factor to the relevant test cases and requirement items by matching textual references and metrics. This step involves text segmentation, keyword detection, and association of model-generated descriptions with stored identifiers. The input of this step is the textual analysis result from the generative AI model, and the output is structured fault-factor and improvement-proposal data stored in an analysis repository.

### Step 12

The server assembles a comprehensive report and transmits it to the terminal for display to the user. The server combines normalized requirement data, structured test case information, summarized test results, and structured fault-factor and improvement-proposal data into a coherent report structure. The server formats the report in a document or markup format with sections organized by requirement, by test case, and by potential fault factor. The server then transmits the report or a link to the report to the terminal. The terminal receives the report data, renders the content in a graphical user interface, and allows the user to inspect details, filter by failure type, and select specific recommendations. The data processing at this step includes data retrieval, formatting, and serialization for transmission. The input of this step is the various structured data sets stored on the server, and the output is a user-readable report presented on the terminal.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional test design systems and tools largely rely on manually authored test cases and static rule-based generation. In such systems, a processor typically accepts requirement documents as unstructured text and stores them, but does not deeply interpret the semantics of the requirements or dynamically adapt test generation to changing functional behavior. As a result, the coverage of abnormal conditions, boundary values, and complex interaction scenarios remains incomplete, especially when new functions are rapidly introduced. This leads to a persistent gap between the logical space of possible failures implied by the requirements and the concrete test cases actually executed on products. Consequently, defects that should have been detectable before release may be overlooked and later appear as market defects.

Further, existing approaches that attempt to use machine learning for quality assurance often treat a learned model as a black box that outputs generic suggestions, without a structured mechanism for generating machine-understandable instructions to the model, without iterative refinement via prompts, and without tight integration between the model outputs and test artifacts stored in a system. In such configurations, the processor does not systematically convert requirements into numerical forms optimized for analysis by a generative artificial intelligence model, nor does it control that model through explicit prompt sentences tailored to specific analysis goals, such as extraction of functional elements, derivation of test conditions, identification of high-risk areas, and prediction of latent defects.

Moreover, conventional systems do not sufficiently exploit historical test data and defect data in a coordinated manner with a generative artificial intelligence model. Even when past data is available, there is no processor-level mechanism that generates, based on this data, explicit prompt sentences instructing the model to consider similar past cases. As a result, knowledge about patterns of previously overlooked defects is not effectively injected into the analysis of new requirements, and the system's ability to proactively prevent recurring market defects remains limited.

Additionally, existing systems generally lack an integrated feedback loop in which user corrections or additional instructions are captured as structured modifications and converted into updated prompt sentences for iterative invocation of a generative artificial intelligence model. Without such a feedback loop, the computer cannot progressively improve the relevance and granularity of generated test cases, test focus points, and defect candidates. This limits the adaptability of the system and constrains its ability to continuously refine its outputs in response to expert feedback.

Accordingly, there is a need for a computer-implemented system and method that improves the functioning of the computer itself by: (i) converting requirement text into numerical sequences suitable for a generative artificial intelligence model; (ii) generating structured prompt sentences that direct the model to perform targeted analyses; (iii) automatically constructing structured test artifacts, including test cases, testing focus points, and defect candidate information, from the model outputs; (iv) leveraging historical test and defect information through prompt generation to guide the model toward high-risk patterns; and (v) enabling an iterative refinement cycle in which user feedback is encoded into new prompt sentences to update and improve generated artifacts. Such a system would enhance the efficiency, accuracy, and coverage of test design processes, and would reduce the occurrence of market defects by improving the underlying computer technology used for requirement analysis and test generation.

The specific processing by the specific processing unit 290 of the data processing device 12 in Example 2 is realized by the following means.

The present invention provides a server comprising a processor configured to receive, via a communication apparatus, character information representing requirements and specifications of a target function from a user and store the character information in a storage apparatus; to preprocess the stored character information using natural language processing to divide the character information into unit information sequences and convert the unit information sequences into numerical information sequences as input information for a generative artificial intelligence model; to extract, from the requirements and specifications, functional elements, input conditions, output conditions, constraint conditions, and abnormal conditions and generate a prompt sentence that instructs the generative artificial intelligence model to analyze the requirements and specifications based on extraction results; to provide the generative artificial intelligence model with the prompt sentence and the input information and execute an analysis process to obtain analysis result information including test condition information and risk information; to automatically construct, based on the analysis result information, test cases including a test identifier, a precondition, input data, an execution procedure, and an expected result, and generate the test cases as structured data; to generate, based on the analysis result information, test key point information indicating testing focus points to be checked with priority during testing and defect candidate information indicating potential defect elements, and store the test key point information and the defect candidate information in the storage apparatus in association with the test cases; to acquire past test information and past defect information from the storage apparatus and, in generating the prompt sentence, generate a further prompt sentence that instructs the generative artificial intelligence model to perform analysis in consideration of similar cases based on the past test information and the past defect information; to generate, based on the analysis result information and the past defect information, a further prompt sentence that instructs the generative artificial intelligence model to construct a prediction mathematical model and identify potential defects, and to output, as the defect candidate information, results obtained from the prediction mathematical model in association with the test cases; and to output the test cases, the test key point information, and the defect candidate information to a user terminal, receive a correction instruction or an additional instruction from the user terminal, and re-input a prompt sentence including the correction instruction or the additional instruction to the generative artificial intelligence model to iteratively update at least one of the test cases, the test key point information, and the defect candidate information. This enables the computer system to autonomously and iteratively transform unstructured requirements into semantically rich numerical representations, to drive a generative artificial intelligence model through explicitly crafted prompt sentences leveraging historical quality data, to automatically produce and refine structured test artifacts capturing high-risk conditions and latent defects, and thereby to improve the technical performance of computer-implemented test design processes by enhancing coverage, reducing overlooked defects, and lowering the incidence of market failures.

The term “communication apparatus” refers to a hardware and software combination that enables data transmission between the server and an external device over a communication network, such as a wired or wireless interface, including but not limited to network interface controllers, routers, and communication protocols.

The term “storage apparatus” refers to one or more hardware storage resources, such as semiconductor memory, magnetic storage, or optical storage, and associated control logic, that collectively store data including requirements, specifications, analysis results, test cases, and historical information.

The term “character information” refers to information expressed as sequences of characters in a character encoding, including letters, numerals, symbols, and control characters, that collectively represent requirements, specifications, or other textual content.

The term “requirements and specifications” refers to textual descriptions defining functional behavior, non-functional properties, constraints, interfaces, and operating conditions that a target function or system is intended to satisfy.

The term “target function” refers to a specific functionality, feature, or component of a software system or information processing system that is to be tested or evaluated.

The term “natural language processing” refers to a class of computational techniques for analyzing, transforming, and interpreting human-language text, including tokenization, segmentation, normalization, syntactic analysis, and semantic analysis.

The term “unit information sequence” refers to an ordered sequence of smaller information units, such as tokens, words, or subword elements, obtained by segmenting character information for subsequent processing.

The term “numerical information sequence” refers to an ordered list of numerical values, such as indices, vectors, or embeddings, corresponding to unit information sequences and suitable for input to a machine learning model.

The term “generative artificial intelligence model” refers to a machine-learned computational model configured to produce new information, such as text, based on input information and parameters, and including models that use neural network architectures such as transformer-based architectures.

The term “input information for a generative artificial intelligence model” refers to digital data, including numerical information sequences and associated control parameters, that is provided as input to the generative artificial intelligence model for performing analysis or generation.

The term “functional elements” refers to abstracted units of functionality derived from requirements and specifications, such as operations, use cases, or system behaviors that the target function is expected to provide.

The term “input conditions” refers to constraints or patterns related to input data or events that must be provided to a target function in order to trigger particular behaviors or states.

The term “output conditions” refers to expected outcomes, responses, or state changes of a target function corresponding to given input conditions and system states.

The term “constraint conditions” refers to limitations, rules, or environmental parameters that restrict or govern how a target function operates, including performance limits, security requirements, and resource bounds.

The term “abnormal conditions” refers to conditions that deviate from normal or expected inputs or states, including error states, invalid data, failure modes, and exceptional situations.

The term “prompt sentence” refers to a sequence of natural language expressions provided as an instruction to a generative artificial intelligence model to define an intended analysis or generation task and to guide the model's behavior.

The term “analysis process” refers to processing performed by a generative artificial intelligence model in response to input information and a prompt sentence to derive structured or unstructured results that interpret the semantics of requirements and specifications.

The term “analysis result information” refers to data produced by the analysis process of a generative artificial intelligence model, including extracted entities, conditions, risk assessments, and other derived attributes.

The term “test condition information” refers to information describing conditions under which tests should be executed, including specific input combinations, preconditions, and expected system states relevant to testing.

The term “risk information” refers to information that characterizes potential risks, such as likelihood and impact of defects or failures, derived from analysis of requirements, specifications, and historical data.

The term “test case” refers to a structured test artifact including at least a test identifier, a precondition, input data, execution procedures, and expected results, intended to verify behavior of a target function.

The term “test identifier” refers to data that uniquely or distinctively identifies a particular test case within a set of test cases.

The term “precondition” refers to a condition relating to system state, configuration, or environment that must be satisfied before a test case is executed.

The term “execution procedure” refers to an ordered sequence of actions or operations to be performed when executing a test case against a target function.

The term “expected result” refers to the behavior, output, or state transition that should occur when a test case is correctly executed under specified preconditions and input data.

The term “structured data” refers to data organized according to a defined schema, such as records or fields in tables or documents, enabling deterministic parsing, storage, and retrieval by computer programs.

The term “test key point information” refers to information that identifies portions of functionality, scenarios, or conditions that should be prioritized or carefully examined during testing.

The term “defect candidate information” refers to information describing potential defect elements or suspected failure modes inferred from analysis of requirements, specifications, and historical defect patterns.

The term “association” refers to a relationship maintained between two or more data entities, such as between test cases and defect candidate information, allowing correlated retrieval or joint processing.

The term “user terminal” refers to a computing device operated by a user, including hardware and software components for inputting data, displaying information, and communicating with the server through a communication network.

The term “correction instruction” refers to an instruction provided by a user that modifies, deletes, or refines previously generated test artifacts or analysis results.

The term “additional instruction” refers to an instruction provided by a user that requests new generation, expansion, or alternative formulations of test artifacts or analysis results beyond those already generated.

The term “past test information” refers to stored information related to previously executed or designed tests, including test cases, execution logs, outcomes, and coverage metrics.

The term “past defect information” refers to stored information representing defects or failures that occurred in prior versions or deployments of a system, including defect descriptions, root causes, and affected functions.

The term “similar cases” refers to historical situations, test scenarios, or defect patterns that share attributes or characteristics with current requirements or functions under analysis.

The term “prediction mathematical model” refers to a computational model, including but not limited to a statistical model or machine learning model, that predicts the occurrence or likelihood of potential defects based on input features derived from requirements and historical data.

In one embodiment, a server implements the claimed system as a network-connected computing apparatus. The server includes at least one processor, a main memory, a non-volatile storage apparatus, and a communication apparatus. The processor is, for example, a multi-core central processing unit, optionally combined with a graphics processing unit or dedicated accelerator configured for matrix operations. The storage apparatus is realized by a combination of semiconductor memory and magnetic storage that stores requirement documents, model parameters, intermediate analysis results, and generated test artifacts. The communication apparatus is realized by a network interface connected to a communication network and supporting wired or wireless communication with one or more terminals.

The terminal operates as a user-facing device. The terminal is, for example, a general-purpose computer, a portable information terminal, or another network-capable device having a display and input interface. The terminal executes browser software or client software that renders a graphical user interface provided by the server, transmits requirement and specification text to the server, and receives and displays generated test artifacts.

The user operates the terminal to author or select requirement and specification information. The user inputs requirements as natural-language character information in a text area of a web page or in another input screen generated by the server. The user includes, for example, descriptions of functional behavior, error handling, and constraints. As a concrete example, the user may input the following requirements:

“The system shall allow users to log in with an email address and password. After 5 consecutive failed login attempts, the account shall be locked for 30 minutes. The system shall provide password reset via email.”

The server receives this character information via the communication apparatus and stores it in the storage apparatus as a record including fields for raw text, a user identifier, and a timestamp. The server also maintains related data structures, such as an index mapping requirement identifiers to test case groups and risk annotations.

The server applies a natural language processing pipeline to the stored character information. The server executes, for example, a tokenizer corresponding to a transformer-based language model implemented on a machine learning framework. The server converts the character-level input into unit information sequences of subword tokens. The server then maps each token to a numerical index using a vocabulary table stored in the storage apparatus. The server thus generates numerical information sequences representing the requirements.

The server further transforms the numerical information sequences into vector representations. The server loads a generative AI model that includes an embedding layer, multiple attention-based layers, and a language modeling head. The server applies the embedding layer to transform each token index into a dense numerical vector. The server uses a positional encoding mechanism to incorporate token position information, and it feeds the resulting tensors into a stack of attention layers. Each attention layer includes multi-head self-attention, normalization, and feed-forward sublayers. Through these operations, the server computes contextualized vector representations that capture the semantics of the requirements and specifications.

The server extracts functional elements, input conditions, output conditions, constraint conditions, and abnormal conditions from the contextualized representations. The server applies, for example, a classifier head that maps the contextual vectors to label probabilities for different requirement element types. The server selects tokens with probabilities above a threshold and aggregates them into elements. In addition, the server applies pattern-based rules to detect specific numeric ranges, comparison operators, temporal constraints, and similar structures, allowing it to detect boundary values and time-based constraints. By combining neural inference with rule-based post-processing, the server obtains accurate structured representations of requirement elements that are difficult for a human operator to derive consistently at scale.

The server generates a prompt sentence for the generative AI model based on the extracted elements. The server constructs the prompt sentence as a natural-language instruction that encodes explicit guidance to the model. The server inserts into the prompt sentence summaries of the extracted functional elements and conditions. As a concrete example, the server may generate a prompt sentence such as:
“You are a QA test designer. Based on the following requirements, generate detailed test cases, including normal, boundary, and error scenarios for the user authentication function. Requirements: [the requirement text].”

The server provides this prompt sentence and selected numerical information sequences as inputs to the generative AI model. The server sets generation parameters such as maximum sequence length, beam width, sampling temperature, and penalty terms for repeated tokens. The server then executes the generative decoding algorithm, such as beam search or nucleus sampling, on the processor or the accelerator. During decoding, the server updates the internal hidden states of the transformer layers at each time step and calculates probability distributions over vocabulary items. The server selects tokens in accordance with the chosen decoding algorithm, thereby generating test case descriptions in a token-by-token manner.

The server decodes the generated token sequences into character information and parses them into structured test cases. The server identifies separators, headings, and enumerations in the generated text and segments the text into fields such as test identifier, preconditions, input data, execution procedure, and expected results. The server stores the resulting structured data in the storage apparatus using a schema, for example, a table for test cases with foreign keys linking to requirement records and risk records. Because the server uses the transformer's contextual embeddings and the extraction pipeline, the generated test cases achieve higher coverage of abnormal conditions and boundary values than manually written test cases, and the generation speed is significantly higher than human drafting.

The server also generates test key point information. The server generates a further prompt sentence that focuses the generative AI model on testing focus points. As an example, the server may construct the following prompt sentence:
“From the following requirements, identify the key testing focus points (areas that require special attention during testing), especially for security, boundary values, and error handling. Output them as a bullet list.”

The server supplies the requirement text and, optionally, a summary of extracted constraint conditions and abnormal conditions in the prompt sentence. The generative AI model then outputs sentences representing test key points such as:
“Verify lockout behavior after multiple failed login attempts.”
“Verify that password reset tokens are invalid after use and after expiration.”

The server parses these items by line breaks and stores them as test key point records associated with the corresponding test cases and requirements.

The server further generates defect candidate information by leveraging both new analysis results and historical information. The server maintains, in the storage apparatus, past test information and past defect information. These records include fields for failure type, root cause classification, associated requirement patterns, and test case identifiers. The server computes, for example, vector representations of historical defect descriptions using the same embedding mechanisms used for requirements. The server calculates similarity scores between new requirements and historical defect patterns by cosine similarity on the contextual embeddings. By doing so, the server identifies “similar cases” and retrieves representative defect patterns.

The server incorporates these similar cases into a prompt sentence designed to instruct the generative AI model to predict potential defects. For example, the server may generate:
“Based on the following new requirements and the summarized patterns of past defects in similar functions, list potential defect factors (possible bugs) that may occur, focusing on security vulnerabilities, input validation issues, and state inconsistencies. New requirements: [requirements]. Past defect summary: [summary].”

The server also uses a prediction mathematical model realized as an additional machine learning component that operates on feature vectors derived from requirements and historical defects. The server defines feature vectors including counts of security-related keywords, complexity metrics based on control flow inferred from the text, and similarity measures to known defect patterns. The server trains the prediction model in advance using supervised learning, minimizing a loss function such as cross-entropy loss or mean squared error depending on the output format (classification or risk score). The server updates model weights by gradient descent or a variant thereof.

The server uses the outputs of the prediction mathematical model—such as probabilities of defect categories or risk scores—to enrich the defect candidate information. The server combines these outputs with the results of the generative AI model and stores structured defect candidate records containing fields for predicted defect type, likelihood, impact, and associated requirement and test case identifiers. This combination of transformer-based language generation with explicit prediction modeling yields more precise and systematic identification of defect candidates than manual review or simple rule-based systems.

The server outputs test cases, test key point information, and defect candidate information to the terminal via the communication apparatus. The terminal displays these artifacts as interactive tables and lists. The user reviews the generated items and issues correction instructions or additional instructions. For example, the user may input a prompt sentence such as:
“Generate additional negative test cases for the user authentication feature, focusing on edge cases for session timeouts and concurrent login attempts.”
or
“Rewrite the generated test cases in a concise tabular format suitable for import into a test management tool.”

The terminal transmits these instructions to the server, which integrates them into new prompt sentences and re-invokes the generative AI model. The server modifies or extends the existing test cases and related records according to the newly generated outputs. This iterative refinement process allows the system to converge to a high-quality, high-coverage test suite while minimizing manual effort.

From a technical standpoint, the server improves computer technology in several ways. First, by converting requirement text into numerical information sequences tailored to a transformer architecture and by using internal contextual embeddings for structured extraction, the server significantly reduces the computational overhead associated with naive text parsing. The server uses batched tensor operations on the accelerator, thereby achieving higher throughput and lower latency compared to systems that process each requirement independently with non-vectorized algorithms.

Second, the use of structured prompt sentences and targeted generation tasks allows the server to reuse a single generative AI model for multiple specialized functions (test case generation, key point identification, defect prediction) without duplicating models. This reduces memory consumption and improves cache locality for model parameters. Because the server controls the model via explicit prompt sentences that encode analysis goals, the server obtains outputs that are organized for direct ingestion into downstream data structures, thus reducing post-processing complexity.

Third, the server's integration of historical test and defect data into similarity computations and predictive modeling leads to more accurate defect candidate identification. The server's computation of similarity scores and risk features at the vector level enables rapid retrieval of relevant past patterns without exhaustive string matching. This approach improves the accuracy of mapping new requirements to known defect classes and reduces false negatives, thereby lowering the probability that critical defects escape into the market.

Fourth, by associating all generated artifacts with explicit identifiers and relational links in the storage apparatus, the server improves data management and traceability. The server can efficiently retrieve all test cases and defect candidates associated with a given requirement or change request. This structured data organization reduces the cost of maintaining and evolving test assets over time and supports automated impact analysis when requirements are modified.

The server's operations differ from mere automation of human test design by employing non-intuitive, model-driven representations and algorithms. The generative AI model processes requirements as high-dimensional vectors in an embedding space, and the attention mechanisms consider long-range dependencies that human reviewers might overlook. The server uses thresholds on attention weights and classification outputs to systematically identify subtle constraint conditions, such as cross-field dependencies or timing relationships, which are difficult and time-consuming to capture manually. The server also performs training and fine-tuning of the generative AI model and the prediction mathematical model with large-scale historical data, adjusting millions or more of model parameters through gradient-based optimization that is not feasible for human reasoning.

In alternative embodiments, the server may use different neural network architectures or training methods. The generative AI model may be a sequence-to-sequence model, a decoder-only transformer, or another architecture capable of conditional text generation. The server may train the model using masked language modeling, causal language modeling, or mixed objectives, and may fine-tune the model on domain-specific requirement and test data. The server may also adopt different error functions, such as focal loss for imbalanced defect categories, and different optimization algorithms, such as adaptive gradient methods, for weight updates. The prediction mathematical model may be realized as a gradient boosting model, a recurrent network, or another supervised learning architecture, as long as it produces defect-related risk indicators from requirement-derived features.

In a further embodiment, the server may be integrated into a continuous integration and deployment environment. The server may retrieve the latest requirement versions and code metadata from a version control system and automatically regenerate test artifacts when changes are detected. The server may compute differences between requirement versions and restrict analysis and generation to changed sections, thereby reducing computation and communication load. The terminal may then notify the user of incremental updates to the test suite, highlighting newly added test cases and revised defect candidates.

In still another embodiment, the server may adjust prompt sentences based on measured performance metrics. The server may monitor the correlation between generated defect candidates and actually observed defects, and refine prompt sentence templates and model hyperparameters accordingly. This closed-loop adaptation leads to further gains in accuracy and efficiency of test artifact generation.

By implementing the above configurations and variations, the server, the terminal, and the user cooperate to realize a concrete, computer-implemented system that transforms unstructured requirement text into structured test artifacts and defect predictions through explicit data structures, neural architectures, and mathematically defined algorithms. This configuration enhances processing speed, improves accuracy of defect prediction, organizes data more effectively, and reduces communication and computation overhead, thereby providing technical improvements over conventional test design systems.

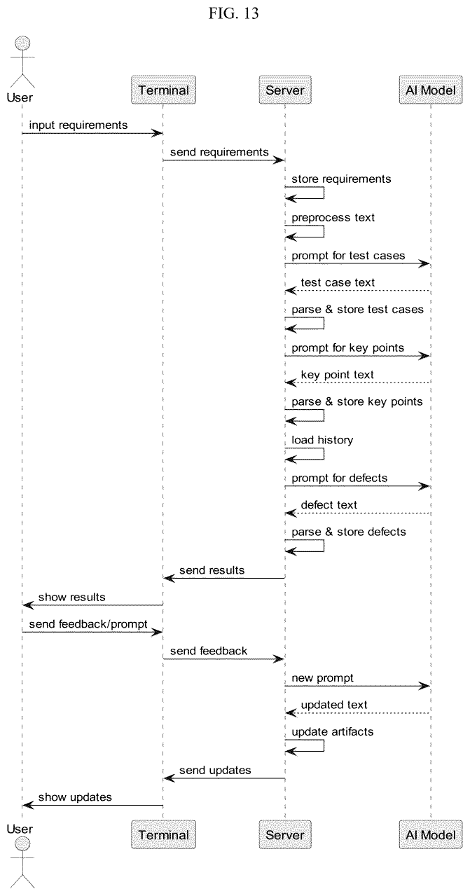

The following describes the processing flow using FIG. 13.

### Step 1

The user prepares requirement and specification text on the terminal.

The user inputs natural-language character information describing functional behavior, constraints, and error handling into an input field displayed by a browser or client application on the terminal.

The terminal receives the character information as text data (input) and displays it in an editable area. The terminal then packages the text data into a request payload and transmits it via a communication network to the server using a communication protocol.

The output of this step is a network request from the terminal to the server that contains requirement and specification text as character information.

### Step 2

The server receives and stores the requirement and specification text.

The server accepts the network request as input via a communication apparatus and passes the payload to a web application component. The server parses the payload to extract the character information representing the requirements and specifications.

The server then writes this character information into a storage apparatus, for example into a record containing fields for a requirement identifier, the raw text, a user identifier, and a timestamp.

The output of this step is stored requirement data in the storage apparatus, indexed and ready for further processing.

### Step 3

The server performs natural language preprocessing and tokenization.

The server retrieves the stored requirement text as input from the storage apparatus. The server applies natural language processing operations such as normalization, sentence segmentation, and tokenization.

The server converts the character-level text into a unit information sequence by splitting it into tokens (words or subwords). The server then maps each token to a numerical index using a vocabulary table associated with the generative AI model, thereby producing a numerical information sequence.

The output of this step is a set of numerical information sequences and corresponding token sequences stored in memory, suitable as input to the generative AI model.

### Step 4

The server generates contextual vector representations using the generative AI model.

The server provides the numerical information sequences as input to the generative AI model. The server applies an embedding layer to transform each token index into a dense vector and applies positional encoding to incorporate order information.

The server then executes attention-based layers of the model, computing attention weights and updating hidden states. Through these computations, the server derives contextualized vector representations for each token and aggregated vectors for sentences or requirement sections.

The output of this step is a set of contextual vectors and hidden state tensors that encode the semantics of the input requirements.

### Step 5

The server extracts structured requirement elements from contextual representations.

The server uses the contextual vectors as input to one or more classifier heads and rule-based extraction modules. The server calculates probabilities that particular tokens or spans correspond to functional elements, input conditions, output conditions, constraint conditions, or abnormal conditions.

The server selects tokens exceeding predetermined probability thresholds and groups them into labeled spans. The server also applies pattern rules to detect numerical ranges, temporal expressions, and conditional phrases. By combining these calculations, the server converts unstructured contextual vectors into structured requirement elements.

The output of this step is a structured representation of the requirements, for example a set of feature records, input condition records, and constraint records stored in the storage apparatus.

### Step 6

The server constructs a first prompt sentence for test case generation.

The server uses the structured requirement elements as input. The server synthesizes a natural-language instruction that explains the generation goal to the generative AI model and embeds summaries of the extracted elements into the text.

For example, the server constructs a prompt sentence such as: “You are a QA test designer. Based on the following requirements, generate detailed test cases, including normal, boundary, and error scenarios for the user authentication function. Requirements: [requirement text].”

The server concatenates this instruction with the original or summarized requirement text and encodes the resulting prompt sentence using the same tokenizer used in Step 3, thereby producing a new sequence of token indices.

The output of this step is an encoded prompt sentence and corresponding token sequence tailored for test case generation.

### Step 7

The server generates test case descriptions using the generative AI model.

The server provides the encoded prompt sentence as input to the generative AI model in generation mode. The server sets generation parameters, such as maximum length, beam size, and sampling temperature.

The server runs a decoding algorithm that iteratively computes output token probabilities at each time step based on the prompt and the model's internal state. At each step, the server selects one or more tokens according to the decoding algorithm and appends them to the output sequence.

The output of this step is a generated token sequence representing one or more test case descriptions in natural-language form.

### Step 8

The server parses and structures the generated test case descriptions.

The server decodes the generated token sequence into character information. The server analyzes the resulting text to identify test case boundaries, headings, numbered lists, and field markers.

The server splits the text into components corresponding to test identifiers, preconditions, input data, execution procedures, and expected results. The server then converts these components into records following a predefined schema and writes them to the storage apparatus.

The output of this step is a collection of structured test case records linked to the original requirements.

### Step 9

The server generates a second prompt sentence for test key point information.

The server uses the structured requirement elements and, optionally, the generated test cases as input. The server constructs a natural-language instruction focused on extracting testing focus points.

For example, the server creates a prompt sentence such as: “From the following requirements, identify the key testing focus points (areas that require special attention during testing), especially for security, boundary values, and error handling. Output them as a bullet list.”

The server concatenates this instruction with relevant requirement summaries and encodes the combined text using the tokenizer.

The output of this step is an encoded prompt sentence designed to elicit test key point information from the generative AI model.

### Step 10

The server generates test key point information using the generative AI model.

The server supplies the encoded second prompt sentence to the generative AI model and initiates another generation process. Using the model's parameters and the prompt context, the server computes probability distributions over tokens at each generation step and selects output tokens according to the chosen decoding strategy.

The server decodes the generated token sequence into text that lists testing focus points. The server splits the text by bullet markers or line breaks into individual key point items.

The output of this step is a set of test key point items stored as individual records associated with relevant test cases and requirements.

### Step 11

The server obtains historical test and defect information for similarity analysis.

The server retrieves past test information and past defect information from the storage apparatus as input. The server converts historical defect descriptions into numerical information sequences and contextual vectors using the same embedding and transformer processes described in Steps 3 and 4.

The server then computes similarity scores between contextual vectors of new requirements and contextual vectors of historical defects, for example using cosine similarity. The server selects historical records whose similarity scores exceed a threshold and aggregates them into a summary of similar cases.

The output of this step is a set of similar historical defect patterns and an associated summary prepared for use in defect prediction prompts.

### Step 12

The server generates a third prompt sentence for defect candidate information.

The server uses the new requirement elements and the similar historical defect summary as input. The server constructs a natural-language instruction directing the generative AI model to list potential defects in light of both new requirements and past patterns.

For example, the server generates a prompt sentence such as: “Based on the following new requirements and the summarized patterns of past defects in similar functions, list potential defect factors (possible bugs) that may occur, focusing on security vulnerabilities, input validation issues, and state inconsistencies. New requirements: [requirements]. Past defect summary: [summary].”

The server encodes this prompt sentence into token indices using the tokenizer.

The output of this step is an encoded defect-oriented prompt sentence suitable for guiding defect candidate generation.

### Step 13

The server generates defect candidate descriptions using the generative AI model.

The server feeds the encoded third prompt sentence into the generative AI model and executes the text generation algorithm. The server calculates output token probabilities conditioned on the prompt and selects tokens to build a sequence of defect candidate descriptions.

The server decodes the generated token sequence into text and segments the text into individual defect candidate items by line breaks or delimiters.

The output of this step is a list of textual descriptions of potential defect elements.

### Step 14

The server enriches defect candidate information with prediction model outputs.

The server uses requirement-derived feature vectors and historical defect features as input to a prediction mathematical model stored in the storage apparatus. The server applies the model to calculate risk scores or category probabilities for potential defects, using a learned weight matrix and activation functions.

The server combines the generative descriptions and numeric risk indicators into structured defect candidate records. Each record contains textual explanation, predicted category, likelihood score, and links to associated requirements and test cases.

The output of this step is a set of structured defect candidate records stored in the storage apparatus.

### Step 15

The server sends generated artifacts to the terminal.

The server collects structured test cases, test key point information, and defect candidate records from the storage apparatus as input. The server formats these data objects into a response payload suitable for transmission, such as a structured response with lists and tables.

The server transmits this payload via the communication apparatus to the terminal. The output of this step is a response received by the terminal containing the generated artifacts.

### Step 16

The terminal displays generated artifacts to the user.

The terminal receives the response payload from the server as input and passes it to a rendering component in a browser or client application. The terminal converts the structured data into visual elements, such as tables of test cases and lists of key points and defect candidates.

The terminal presents these elements on a display device, allowing the user to scroll, filter, and inspect individual items.

The output of this step is a visual representation of generated test artifacts on the terminal's display.

### Step 17

The user issues correction instructions or additional instructions.

The user reviews the displayed test cases, key points, and defect candidates on the terminal. The user edits text fields or enters new instructions in an input area, specifying desired changes or requesting further generation.

For example, the user may input a prompt sentence such as: “Generate additional negative test cases for the user authentication feature, focusing on edge cases for session timeouts and concurrent login attempts.”

The terminal captures these user inputs as correction or additional instruction data. The output of this step is an updated instruction set ready to be sent to the server.

### Step 18

The terminal transmits updated instructions to the server.

The terminal packages the correction or additional instructions, including any modified test case fields or new prompt sentences, into a new request payload. The terminal sends this payload via the communication network to the server using the communication apparatus.

The output of this step is a network request containing user feedback and updated instructions delivered to the server.

### Step 19

The server iteratively updates generated artifacts based on user instructions.

The server receives the updated instructions as input and parses them to determine which artifacts require modification or extension. The server constructs new prompt sentences that incorporate the user's corrections or additional generation requests, optionally inserting references to existing test cases or requirements.

The server re-invokes the generative AI model with these new prompt sentences, generates new or revised text, parses the results into structured records, and updates corresponding entries in the storage apparatus.

The output of this step is an updated set of test cases, test key point information, and defect candidate records that reflect both automated analysis and user-driven refinement.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern software development, the generation and management of test cases for new or modified functions remains heavily dependent on manual effort by test engineers. Conventional tools typically accept requirements as unstructured text, provide limited assistance in understanding the semantic content of the requirements, and at best offer static templates or rule-based expansions of test cases. As a result, the coverage, priority, and focus of test cases strongly depend on the subjective judgment and experience of individual engineers. This leads to several technical problems in computer-implemented testing workflows.

First, conventional systems do not effectively transform unstructured requirement text into a structured representation suitable for automated downstream processing. Natural language requirements are stored as plain text without extracting functional information, input and output conditions, or constraint conditions, making it difficult for a computer system to systematically generate high-quality test data. This lack of structuring causes inefficiency in computation and restricts the degree to which automated processing can be applied.

Second, existing approaches that use machine learning or rule-based techniques to support test generation often treat a generative AI model as a one-shot text expansion tool. These approaches do not construct carefully designed prompt sentences that embed structured requirement information, nor do they iteratively refine prompts based on additional signals such as historical defect data or user emotion information. Consequently, the generative AI model output lacks alignment with risk factors and user-experienced pain points, and the computer system is unable to optimize test case selection and prioritization in a data-driven manner.

Third, conventional test management systems do not integrate heterogeneous sources of technical feedback—such as past test history, past defect history, runtime behavior observed in virtual environment simulations, and user or operator emotion data—into a unified computational framework. Past test results and defect logs may be stored, but they are rarely combined algorithmically with simulation-derived abnormal event information and emotion analysis results. Without such integration, a computer system cannot automatically compute an integrated risk evaluation that accurately reflects both objective system behavior and subjective user experience, and cannot automatically determine execution order and resource allocation for test cases.

Fourth, systems that do incorporate simulations of physical or cyber-physical systems, such as robots or factory automation devices, often require manual creation of simulation scenarios. Test engineers must translate test descriptions into simulation configuration files by hand, which is error-prone and not scalable. Moreover, logs produced by simulation runs are typically analyzed manually or with ad-hoc scripts, preventing systematic feedback of detected anomalies into the test generation pipeline.

Fifth, current test management tools do not systematically use user or operator emotion as a quantitative signal for adjusting test priorities. Feedback such as “the payment is slow” or “the movement is not smooth” is often captured in free text and loosely tracked, but there is no standardized emotion analysis process that converts such feedback into emotion type and intensity information, maps that information to affected functions, and automatically strengthens test cases for those functions. This results in a disconnect between user experience and the technical test plan maintained by the computer system.

Accordingly, there is a need for a computer-implemented system that (i) converts unstructured requirements into structured analysis target information, (ii) generates and iteratively refines prompt sentences for a generative AI model to obtain test case information, key test item information, and defect factor information, (iii) performs importance calculation based on past history to assign risk evaluation information and recommended priority information, (iv) incorporates emotion analysis of user feedback to adjust test priorities and to generate enhanced test cases via additional prompt sentences, (v) automatically generates and analyzes simulation scenarios for virtual environments, and (vi) integrates all of these heterogeneous signals into an automated test planning process that determines execution order and resource allocation for test cases. Such a system would improve the functioning of the computer itself in the domain of test management by enabling more accurate, consistent, and efficient computation of test sets and test plans, and by reducing the reliance on ad-hoc human decision making.

The specific processing by the specific processing unit 290 of the data processing device 12 in Application Example 2 is realized by the following means.

The present invention provides a server comprising a processor configured to receive functional requirements and performance requirements input by a user and store the functional requirements and the performance requirements in a storage region; to perform, using natural language processing, a structuring process on the functional requirements and the performance requirements to extract functional information, input condition information, output condition information, and constraint condition information; to generate a first prompt sentence including analysis target information comprising the functional information, the input condition information, the output condition information, and the constraint condition information, and to cause a generative AI model to receive the first prompt sentence as input; to receive test case information, key test item information, and defect factor information output from the generative AI model, and to format the test case information as test data including test procedure information, expected result information, and test priority information; to perform importance calculation processing on the test data and the defect factor information based on past test history information and past defect history information, and to assign risk evaluation information and recommended priority information to each test case; to execute emotion analysis processing on evaluation information including an emotion input by a user, thereby converting the evaluation information into emotion type information and emotion intensity information, and, based on the emotion type information and the emotion intensity information, to adjust the recommended priority information for test cases related to a function associated with the emotion and to generate a second prompt sentence including additional test request information; to cause the generative AI model to receive the second prompt sentence as input to acquire enhanced test case information based on the emotion information, and to integrate the enhanced test case information into the test data; and to transmit integrated test data, the key test item information, and the defect factor information to a terminal device and cause the terminal device to present the integrated test data, the key test item information, and the defect factor information as display data. This enables the computer-implemented test generation and planning process to automatically transform unstructured requirements and subjective feedback into structured, risk-aware, and emotion-sensitive test data, to iteratively refine test cases via prompt-driven interaction with a generative AI model, and to compute optimized execution order and resource allocation for test cases based on integrated risk evaluation, thereby improving the technical performance of the server in terms of test coverage, prioritization accuracy, and processing efficiency.

The term “functional requirements” refers to requirement information describing functions or behaviors that a system must perform, expressed as operations, actions, or services provided to a user or another system.

The term “performance requirements” refers to requirement information describing quantitative or qualitative performance constraints of a system, including response time, throughput, resource usage, reliability, or scalability.

The term “storage region” refers to a hardware or software controlled memory area, such as a volatile memory or nonvolatile memory, that is configured to store requirement information, test data, and analysis results.

The term “natural language processing” refers to a set of computational techniques executed by a processor to analyze and manipulate human-readable text, including tokenization, parsing, entity extraction, and semantic interpretation.

The term “structuring process” refers to a process in which unstructured text data is converted into a structured representation by extracting and organizing semantic elements such as functions, conditions, and constraints.

The term “functional information” refers to structured data representing operations, behaviors, or features of a system that are extracted from unstructured requirement text.

The term “input condition information” refers to structured data representing inputs, preconditions, or environmental states required to execute a function or test case.

The term “output condition information” refers to structured data representing outputs, postconditions, or observable results produced by execution of a function or test case.

The term “constraint condition information” refers to structured data representing limitations, rules, or boundary conditions that restrict how a function may operate or how a test may be executed.

The term “analysis target information” refers to a collection of structured elements, including functional information, input condition information, output condition information, and constraint condition information, used as content for analysis by a generative AI model.

The term “prompt sentence” refers to an instruction sentence or instruction text that is supplied as input to a generative AI model to direct the model to perform a specific analysis or generation task.

The term “first prompt sentence” refers to a prompt sentence that includes analysis target information derived from requirements and is used to instruct a generative AI model to generate initial test case information, key test item information, and defect factor information.

The term “second prompt sentence” refers to a prompt sentence that includes additional test request information reflecting emotion analysis and is used to instruct a generative AI model to generate enhanced test case information.

The term “third prompt sentence” refers to a prompt sentence that includes abnormal event information obtained from simulation logs and is used to instruct a generative AI model to generate additional test case information and additional key test item information.

The term “generative AI model” refers to an artificial intelligence model that receives a prompt sentence as input and automatically generates output text or structured data such as test cases, key test items, or defect factors based on learned language patterns.

The term “test case information” refers to generated data that describes a specific test to be executed, including conditions, operations, and expected outcomes for verifying a function of a system.

The term “key test item information” refers to generated data indicating test focus areas or important verification points that should be emphasized when executing tests.

The term “defect factor information” refers to generated data identifying potential causes, conditions, or elements that are likely to lead to defects or failures in a system.

The term “test data” refers to a structured collection of test case information including at least test procedure information, expected result information, and test priority information.

The term “test procedure information” refers to data describing a sequence of actions, inputs, and conditions to be performed during execution of a test case.

The term “expected result information” refers to data describing outputs, system states, or observable behaviors that are expected to occur if a test case passes.

The term “test priority information” refers to data indicating a relative importance or urgency for executing each test case, which may be used to order test execution.

The term “importance calculation processing” refers to computational processing in which past test history information and past defect history information are used to calculate a degree of importance or risk associated with each test case or defect factor.

The term “past test history information” refers to stored data describing previous test executions, including executed test cases, results, timestamps, and environments. The term “past defect history information” refers to stored data describing previously observed defects or failures, including defect types, occurrence conditions, and associated functions.

The term “risk evaluation information” refers to calculated data that quantitatively or qualitatively represents a risk level associated with a test case, function, or defect factor.

The term “recommended priority information” refers to priority information for a test case that is determined by importance calculation processing and is recommended for use when planning test execution.

The term “evaluation information including an emotion” refers to user-provided information, such as feedback text or comments, that expresses an emotional reaction to system behavior or functionality.

The term “emotion analysis processing” refers to computational processing that interprets evaluation information to determine emotion type information and emotion intensity information.

The term “emotion type information” refers to classification data indicating a type of emotion, such as satisfaction, dissatisfaction, frustration, or anxiety, derived from evaluation information.

The term “emotion intensity information” refers to data indicating a strength or magnitude of an emotion type, represented for example as a numerical score or as levels.

The term “additional test request information” refers to data that specifies reinforcement or extension of test coverage for one or more functions based on emotion analysis results.

The term “enhanced test case information” refers to additional or modified test case information generated by a generative AI model in response to a prompt sentence that incorporates emotion analysis or other secondary signals.

The term “integrated test data” refers to a combined set of test data including initial test case information and enhanced test case information, and optionally including associated evaluations or metadata.

The term “terminal device” refers to an electronic device such as a client computer, portable terminal, or display device that receives test-related information from a server and presents the information to a user.

The term “display data” refers to formatted information generated for presentation on a screen of a terminal device, including lists, tables, or graphical indicators related to test cases and analysis results.

The term “test cases related to physical operation” refers to test cases that involve verification of physical movement, actuation, or interaction of a machine, apparatus, or controlled object in a real or virtual environment.

The term “operation condition information” refers to data describing physical or logical conditions under which a physical operation test is executed, including positions, speeds, loads, and environmental parameters.

The term “scenario information for verification in a virtual environment” refers to structured configuration or script data used to control a simulation environment in order to reproduce specified operation conditions and sequences.

The term “simulation processing for operation verification” refers to computational processing that executes a simulation in a virtual environment based on scenario information to verify system behavior or motion without using a physical device.

The term “operation log information” refers to time-series data recorded during simulation or actual operation that describes states, events, or measurements such as positions, velocities, forces, or errors.

The term “anomaly detection processing” refers to computational processing that analyzes operation log information to identify abnormal patterns, deviations, or events that differ from expected or nominal behavior.

The term “abnormal event information” refers to data describing one or more detected anomalies, including type, time, location, magnitude, or associated conditions of abnormal behavior.

The term “additional test case information” refers to new or extended test case information generated based on abnormal event information, intended to further investigate or prevent the detected anomalies.

The term “additional key test item information” refers to key test item information generated or updated based on abnormal event information, indicating test focus areas that have become more important due to detected anomalies.

The term “integrated risk evaluation information” refers to risk evaluation data computed by taking into account test case information, key test item information, defect factor information, emotion analysis results, and abnormal event information.

The term “execution order information” refers to data specifying an ordered sequence in which test cases are to be executed, determined based on integrated risk evaluation information.

The term “resource allocation information” refers to data specifying allocation of computing resources, human resources, or time resources to test cases or test groups based on risk or priority.

The term “test plan” refers to a plan that includes at least execution order information and resource allocation information, and that is used by a test management system or user to schedule and control test execution.

In one embodiment, a server, a terminal, and a user cooperate to implement the claimed system for automated generation and refinement of test data using a generative AI model and carefully constructed prompt sentences. The following description provides exemplary configurations, data structures, processing methods, and technical effects sufficient to enable a person skilled in the art to practice the invention.

A. Hardware and software configuration

The server uses a hardware platform including at least one general-purpose processor, a main memory, a nonvolatile storage device, and a network interface. For example, the server uses a multi-core processor (such as an x86-compatible central processing unit), 32 GB or more of random access memory, a solid-state drive as nonvolatile memory, and an Ethernet or wireless network interface. The server executes a server operating system such as a Unix-like operating system and runs application software implemented in a high-level language such as Python.

The server uses an application stack including:
A web application framework to expose application programming interfaces (APIs) over Hypertext Transfer Protocol.
A relational database management system such as a structured query language database for storing requirement information, test data, logs, and models.
A natural language processing library such as a tokenization and parsing toolkit for structuring text requirements.
A numerical computation library such as a tensor computation library to accelerate matrix operations.
A machine learning framework such as a deep learning framework to execute models for emotion analysis and anomaly detection.
A client library for accessing an external or internal generative AI model (for example, over a representational state transfer API).

The terminal uses a hardware platform such as a personal computer, a tablet, or a handheld device. The terminal executes a client operating system and runs a browser or native application. The terminal includes a display, an input device, and a communication interface. The terminal communicates with the server via a network and presents display data generated by the server.

The user operates the terminal to input requirements, provide feedback, and review test data.

### B. Data Structures and Internal Representations

The server stores requirements, prompts, test data, and analysis results in structured form. The server defines, as one example, the following logical tables in the database:
A requirement table, which stores raw requirement text as character strings, together with identifiers, timestamps, and project identifiers.
A parsed requirement table, which stores structured fields such as function name, input parameter list, output description, and constraint list.
A prompt table, which stores prompt sentences, prompt identifiers, associated requirement identifiers, and prompt types (for example, first prompt sentence, second prompt sentence, third prompt sentence).
A test case table, which stores, for each test case, a test identifier, a title, precondition description, test steps, expected result description, initial priority, risk evaluation score, and recommended priority.
A key test item table, which stores test focus descriptions and associated requirement identifiers.
A defect factor table, which stores candidate defect causes, descriptions, and links to requirement elements.
A feedback table, which stores user feedback text, associated function identifiers, and timestamps.
An emotion table, which stores emotion type, emotion intensity, and links to feedback records.
A simulation scenario table, which stores physical operation conditions such as initial positions, velocities, payload data, and simulation duration.
An operation log table, which stores time-series simulation outputs such as joint angles, forces, and error codes.
A risk integration table, which stores integrated risk evaluation values, execution order indices, and resource allocation values for each test case.

By explicitly representing these elements in structured tables, the server improves data management and enables index-based retrieval, batch computations, and incremental updates that are not feasible with purely unstructured text.

### C. Natural Language Structuring of Requirements

The server analyzes requirement text using natural language processing. For example, the server uses a syntactic parser to convert each sentence into a dependency tree, and then maps certain syntactic patterns to semantic roles. The server identifies verbs representing operations (for example, “log in,” “classify,” “assemble”), and associates them with subject phrases (for example, “user,” “robot,” “system”) and object phrases (for example, “email and password,” “object,” “component”). The server recognizes conditional clauses introduced by terms such as “if”′ or “when,” and records them as input conditions. The server extracts:
Functional information, including operation names and associated entities.
Input condition information, including data types, ranges, and preconditions.
Output condition information, including expected state changes and messages.
Constraint condition information, such as upper bounds on response time or numeric limits on parameters.

For example, when the user inputs a requirement such as:
“The system shall allow a user to log in using an email address and a password, and the password must be at least eight characters long.”
the server identifies “log in” as a function, “email address” and “password” as inputs, and “password must be at least eight characters long” as a constraint. The server writes these structured elements to the parsed requirement table.

This structuring reduces ambiguity and enables algorithmic generation of prompts and test cases. Because the server performs rule-based mapping from syntactic dependencies to semantic roles, the process is more deterministic and repeatable than ad-hoc manual interpretation.

### D. Generative AI Model and Prompt Sentence Construction

The server uses a generative AI model that implements a neural network architecture, for example, a transformer encoder-decoder network composed of multiple attention layers, feed-forward layers, and embedding layers. The generative AI model uses a learned parameter set that maps sequences of token embeddings to output token sequences. The server does not train the generative AI model in this embodiment; instead, the server uses a pre-trained model via an API. However, the server controls the behavior of the model by generating prompt sentences in a particular format and sequence, thereby shaping the distribution of model outputs.

The server constructs a first prompt sentence by concatenating instructional text with the structured requirement representation. For example, the server can generate:
“Requirements: The system must allow a user to log in using an email address and a password. The password must be at least eight characters long. Analyze these requirements and generate detailed test cases, key test points, and potential defect factors.”
or, for a robotics use case:
“Requirements: A factory robot must perform a new assembly motion for part A. The robot moves from position X to position Y while maintaining a maximum speed of 0.5 m/s and avoiding collisions with obstacles. Analyze these requirements and generate detailed test cases, key test points, and potential defect factors related to motion safety and smoothness.”

The server includes delimiters and section headings in the prompt sentence to encourage the generative AI model to output distinct sections for test cases, key test points, and defect factors. For example, the server may append:
“Output three sections titled TEST_CASES, KEY_POINTS, and DEFECT_FACTORS.”

This nonconventional prompt structure is designed to exploit the generative AI model's sequence modeling ability while producing machine-parsable output, improving both the precision and the computational efficiency of the downstream parsing stage.

### E. Parsing and Structuring AI-Generated Outputs

The server receives text output from the generative AI model and applies deterministic parsing rules. If the output follows a prescribed section structure (for example, headings followed by numbered items), the server uses pattern matching to identify each section and each item. For each test case, the server attempts to extract:
A description line, which it stores as the title.
Preconditions, which it stores as precondition description.
Steps, which it stores as a multi-line procedure.
Expected results, which it stores as expected result description.

The server optionally uses pattern markers such as “Preconditions:”, “Steps:”, and “Expected Result:” in the prompt sentence to guide the format of the output. By designing prompt sentences in this way, the server ensures that the generative AI model outputs data that the server can deterministically map into the test case table. This reduces parsing errors and allows the server to run the process repeatedly without manual intervention.

### F. Emotion Analysis and Enhanced Prompts

The server processes feedback provided by the user to account for subjective experience in test planning. For example, the user can enter:
“Payment is slow.”
or:
“The robot movement is not smooth.”

The server performs emotion analysis using a neural network classifier implemented in a deep learning framework. In one embodiment, the server uses a bidirectional recurrent network or a transformer classifier trained on labeled emotion data. The classifier uses word embeddings or subword embeddings as input features and outputs a probability distribution over emotion types such as satisfaction, dissatisfaction, frustration, and anxiety. The server calculates emotion intensity as a function of the probability or as the maximum probability value for the detected class.

The server stores emotion type and intensity values in the emotion table. The server then maps the feedback to related requirement elements by searching for keywords in the feedback text and linking them to function names stored in the parsed requirement table. For example, the server links “payment” to a payment function and “movement” to a robot motion function.

Using these mappings, the server adjusts recommended priority values for test cases associated with the affected functions. In addition, the server generates a second prompt sentence that instructs the generative AI model to strengthen test coverage for specific aspects. For example, the server can generate:
“User feedback: ‘Payment is slow.’ Detected emotion: dissatisfaction (intensity 0.92). Based on the existing test cases for the payment function, generate additional performance and load test cases focusing on transaction latency, concurrency, and timeout behavior.”
or:
“User feedback: ‘The robot movement is not smooth.’ Detected emotion: frustration (intensity 0.88). Based on the existing motion-related test cases, generate additional test cases focusing on jerk, vibration, and path accuracy, and propose key test points for smoothness evaluation.”

The server passes these second prompt sentences to the generative AI model. The resulting enhanced test case information is then integrated into the test data. This approach is different from manual prioritization because the server quantitatively uses emotion labels and intensities to parameterize the prompt sentences and systematically expand test coverage, allowing the computer to compute prioritization and generation results that reflect user experience in a repeatable manner.

### G. Simulation Scenario Generation and Anomaly Detection

For physical operation tests, the server converts test cases into simulation scenarios in a virtual environment. The server reads motion-related test cases, extracts operation condition information (for example, start position, target position, speed, payload), and writes them into a scenario representation. This representation can be expressed, for example, as a configuration record that the simulation platform reads to set up a robot model and environment.

The server then invokes a simulation program, such as a rigid-body dynamics simulator, by passing the scenario representation. The simulator computes motion trajectories, contact forces, and other physical quantities over time. The simulator outputs operation log information, which the server stores in the operation log table.

The server performs anomaly detection processing on the operation log information. In one embodiment, the server computes derived features such as:
Maximum deviation between commanded and measured positions.
Peak jerk (time derivative of acceleration).
Number of collision events.
Duration of contact events.

The server then applies a detection algorithm, which may include:
Threshold-based rules, where the server flags values that exceed predetermined safety limits.
A trained anomaly detection model, for example, an autoencoder or isolation forest, which examines feature vectors and outputs anomaly scores.

The server stores abnormal event information, including anomaly type, time index, sensor values, and linked test case identifier. The server then generates a third prompt sentence such as:

“In a simulated execution of the assembly motion for part A, the following anomalies were observed: high jerk near the end of motion, repeated small collisions with obstacle B, and excessive joint torque at joint 3. Generate additional test cases and key test points to investigate and mitigate these anomalies.”

The generative AI model outputs additional test cases and key test items, which the server integrates into the test data. This feedback loop, which uses detailed physical metrics from simulation logs to drive further test generation, enables the computer system to refine test coverage in a way that would be impractical to perform manually at scale.

### H. Integrated Risk Evaluation and Test Planning

The server computes integrated risk evaluation information based on multiple heterogeneous signals: the test case set, defect factors, emotion analysis, and anomalies detected by simulation. The server, for example, assigns numerical weights to:
Past defect frequencies per function.
Complexity of input conditions (for example, number of parameters, value ranges).
Severity and intensity of emotions (for example, dissatisfaction).
Severity of anomalies in physical simulations.

The server calculates, for each test case, a risk evaluation score, such as a weighted sum or a learned function of these inputs. The server then ranks test cases by risk evaluation score and writes execution order values to the risk integration table. The server also calculates resource allocation information, such as estimated execution time and required simulation resources, and assigns them based on risk. These computations are performed algorithmically and can be optimized by matrix and vector operations in a numerical computation library, improving processing speed and consistency relative to manual planning.

The server then generates a test plan that includes execution order and resource allocations. The server sends the plan, along with the underlying test data and risk evaluations, to the terminal. The terminal displays, for example, tables and charts that highlight high-risk test cases, functions with strong negative feedback, and motion scenarios with anomalies. The user reviews and may approve the plan, but the core ordering and resource decisions are computed automatically by the server.

### I. Technical Improvements and Non-Abstract Nature

The described system provides improvements to computer technology itself, not merely automation of a human workflow. The server uses specific data structures, model interfaces, and algorithmic flows to:
Increase processing speed: by structuring unstructured requirement text into machine-parsable representations and crafting prompt sentences with explicit section markers, the server reduces the need for manual interpretation and simplifies parsing, enabling batch processing of many requirements with lower computational overhead.
Improve accuracy: by integrating emotion analysis results and simulation-derived abnormal event data into risk evaluation, the server uses multiple independent signals to compute test priorities and generate additional test cases, reducing false negatives in defect detection compared with approaches that rely on requirements alone.
Enhance data management: by storing prompts, structured test cases, emotion results, and simulation logs in linked relational tables, the server supports traceability from each test case back to original requirements, user feedback, and anomalies, enabling consistent updates and audits.
Improve computational efficiency: by designing prompt sentences that elicit structured responses from the generative AI model, the server reduces the entropy of the output and simplifies downstream computation. This is a nonconventional use of a generative AI model that optimizes the interaction protocol itself, rather than merely using the model as a black box text generator.

The server applies neural networks and simulation-based anomaly detection in ways that follow distinct, non-human rules. For example, the transformer-based generative AI model uses multi-head attention to compute contextualized token embeddings, and the emotion classifier uses gradient-based weight updates with backpropagation on a loss function such as cross-entropy. The anomaly detector can be an unsupervised autoencoder that minimizes reconstruction error under a mean squared error loss, and flags anomalies based on threshold exceedance of that error. These models process high-dimensional feature spaces and time-series data in ways not feasible for humans, and the resulting scores are fed into deterministic ranking and planning algorithms.

In alternative embodiments, the server may:
Replace the external generative AI service with a locally deployed language model trained on domain-specific test data.
Use different neural architectures for emotion analysis, such as convolutional networks or hybrid recurrent-transformer models.
Use a different database technology, such as a document store, while maintaining the logical structure of the data relationships.
Extend the simulation integration to additional physical domains, such as autonomous vehicles or industrial process control, by adapting the scenario representation and log feature extraction.

Regardless of such variations, the server, terminal, and user cooperate according to the disclosed architecture to implement the claimed functions. The system uses explicit data structures, algorithms, and model interactions that make the computer system operate in a more efficient, accurate, and technically improved manner for the generation, prioritization, and planning of tests, and ties these computations to real-world control and verification of software, robotic motion, and other technical equipment.

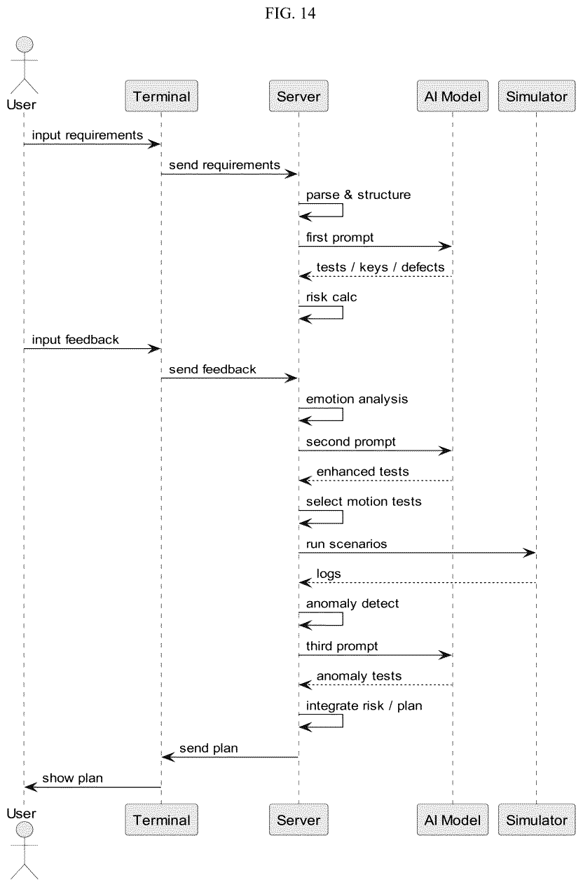

The following describes the processing flow using FIG. 14.

### Step 1

User uses the terminal to input requirement text and optional attachment files.

User enters functional requirements and performance requirements into an input form on the terminal and optionally uploads specification documents.

Input: natural language requirement text and files.

Output: a structured request message sent from the terminal to the server.

Terminal converts the input into a data structure containing user identifiers, raw text, and file metadata, and transmits this structure to the server via a network protocol.

### Step 2

Server receives and stores the raw requirement data.

Server accepts the incoming request, extracts the requirement text, metadata, and attachments, and writes them into a requirement table and a file storage area in a database system.

Input: structured request message from the terminal.

Output: stored raw requirement records and file references in the database.

Server performs data validation, assigns unique identifiers, and commits the records to persistent storage.

### Step 3

Server performs natural language structuring of the requirement text.

Server reads the stored requirement text from the database and applies a natural language processing library to segment sentences, identify parts of speech, and build dependency trees.

Input: raw requirement text associated with a requirement identifier.

Output: structured elements including functional information, input condition information, output condition information, and constraint condition information. Server maps syntactic patterns to semantic roles, extracts functions, inputs, outputs, and constraints, and writes these structured values into a parsed requirement table.

### Step 4

Server constructs a first prompt sentence for the generative AI model.

Server retrieves the structured elements from the parsed requirement table and combines them with a predefined instruction template to form a prompt sentence.

Input: functional information, input condition information, output condition information, and constraint condition information.

Output: a first prompt sentence text suitable for the generative AI model.

Server concatenates these elements using delimiters and headings, checks token length, and stores the final prompt sentence in a prompt table.

### Step 5

Server sends the first prompt sentence to the generative AI model and obtains initial test-related output.

Server calls an API endpoint for the generative AI model and provides the first prompt sentence as input, specifying generation parameters.

Input: first prompt sentence retrieved from the prompt table.

Output: text output including test case descriptions, key test item descriptions, and defect factor descriptions.

Server waits for the response, receives it as a text string, and logs the association between the prompt identifier and the model output in the database.

### Step 6

Server parses the generative AI model output into structured test data.

Server analyzes the returned text, locates section headings such as “TEST_CASES”, “KEY POINTS”, and “DEFECT_FACTORS”, and splits the text into corresponding sections.

Input: raw text output from the generative AI model.

Output: structured test case records, key test item records, and defect factor records. Server extracts titles, preconditions, steps, and expected results for each test case, assigns internal identifiers, and inserts records into the test case table, key test item table, and defect factor table.

### Step 7

Server computes importance and risk evaluation for each test case.

Server retrieves test cases and defect factors along with past test history and defect history from the database, and applies a scoring algorithm to determine a risk level.

Input: test case records, defect factor records, past test history information, and past defect history information.

Output: 4updated test case records enriched with risk evaluation information and recommended priority information.

Server transforms these inputs into numerical feature vectors, performs calculations such as weighted sums or statistical analysis, and writes the computed scores and priorities back into the test case table.

### Step 8

User provides feedback expressing emotion about system behavior.

User enters feedback such as “Payment is slow” or “The robot movement is not smooth” into a feedback input screen on the terminal.

Input: natural language feedback text typed by the user.

Output: a feedback message transmitted from the terminal to the server.

Terminal packages the feedback with references to relevant functions or screens and sends this message to the server for further processing.

### Step 9

Server performs emotion analysis on user feedback.

Server retrieves the feedback text from the feedback message and applies an emotion classification model implemented in a machine learning framework.

Input: feedback text and optional context describing the affected function.

Output: emotion type information (such as dissatisfaction or frustration) and emotion intensity information (such as a numerical score).

Server converts the text into embeddings, applies the neural network classifier to obtain probabilities for each emotion type, selects the highest-probability emotion, computes intensity, and stores the results in the emotion table linked to the feedback record.

### Step 10

Server adjusts test case priorities and generates a second prompt sentence based on emotion.

Server identifies test cases associated with the function referenced in the feedback, and modifies their recommended priority values according to the emotion type and intensity.

Input: emotion type information, emotion intensity information, and related test case identifiers.

Output: updated test case priorities and a second prompt sentence for enhanced test generation.

Server increases the priority for affected test cases, then constructs a second prompt sentence such as “User feedback: ‘Payment is slow.’ Detected emotion: dissatisfaction. Based on existing payment test cases, generate additional performance and load test cases focusing on latency, concurrency, and timeout behavior.” and writes this second prompt sentence into the prompt table.

### Step 11

Server sends the second prompt sentence to the generative AI model and obtains enhanced test case information.

Server calls the generative AI model API again, providing the second prompt sentence as input to request reinforcement of test coverage.

Input: second prompt sentence containing additional test request information.

Output: enhanced test case descriptions and, optionally, additional key test items.

Server receives the model output, logs the association with the prompt identifier, and stores the raw text in the database.

### Step 12

Server parses enhanced test case output and integrates it into the test data.

Server analyzes the enhanced output using the same parsing rules as for the initial output, and extracts structured test cases and key test items.

Input: raw enhanced test case text from the generative AI model.

Output: additional test case records and additional key test item records integrated with existing test data.

Server inserts the new records into the test case table and key test item table, links them to the relevant functions and feedback records, and recalculates priorities where necessary.

### Step 13

Server generates simulation scenarios for test cases related to physical operations.

Server selects test cases that involve robot motion or other physical device actions, and extracts operation condition information such as starting pose, target pose, speed, and payload.

Input: motion-related test case records from the test case table.

Output: simulation scenario records describing conditions for virtual environment verification.

Server formats this information into a scenario structure recognized by a simulation program and stores scenario references in the simulation scenario table.

### Step 14

Server executes simulation processing and records operation logs.

Server invokes a simulation engine, provides the scenario records as configuration, and instructs the simulator to run virtual executions of the operations.

Input: scenario information for verification in a virtual environment.

Output: operation log information representing time-series physical quantities and events.

Server collects log data produced by the simulator, converts it into a standardized time-series format, and stores the logs in the operation log table.

### Step 15

Server performs anomaly detection on operation logs and generates a third prompt sentence.

Server reads operation logs for each scenario, computes features such as maximum deviation, peak jerk, collision counts, and torque peaks, and compares these values against thresholds or an anomaly detection model.

Input: operation log information and anomaly detection parameters or models.

Output: abnormal event information and an associated third prompt sentence.

Server records detected anomalies in the abnormal event table and generates a third prompt sentence such as “In simulation of the new assembly motion, high jerk and repeated small collisions were detected. Generate additional test cases and key test points to check motion smoothness and collision avoidance.” and stores the third prompt sentence in the prompt table.

### Step 16

Server sends the third prompt sentence to the generative AI model and updates test data with anomaly-focused tests.

Server provides the third prompt sentence to the generative AI model to obtain new tests focusing on the detected anomalies.

Input: third prompt sentence containing abnormal event information.

Output: anomaly-focused additional test case information and key test item information.

Server parses the output, creates corresponding test case and key test item records, associates them with the relevant motion scenarios, and updates risk scores to reflect the new anomaly information.

### Step 17

Server computes integrated risk evaluation and determines execution order and resource allocation.

Server retrieves all test cases, associated risk evaluations, emotion results, and abnormal event records, and calculates an integrated risk score for each test case.

Input: test case records, risk evaluation information, emotion type and intensity information, and abnormal event information.

Output: integrated risk evaluation information, execution order information, and resource allocation information for each test case.

Server performs numerical operations such as weighted sums, normalization, and sorting to compute rankings and allocations, and stores these results in the risk integration table.

### Step 18

Server prepares display data and sends it to the terminal.

Server collects test case details, key test items, defect factors, risk evaluations, execution order, and resource allocations into a display-oriented data structure.

Input: integrated test data and planning information from multiple tables.

Output: formatted display data payload for the terminal.

Server serializes this data into a structured format, attaches identifiers and grouping information, and transmits the payload to the terminal over the network.

### Step 19

Terminal renders the received information for the user.

Terminal receives the display data payload, parses it, and presents lists, tables, and visual indicators on the display.

Input: display data payload from the server.

Output: rendered screens showing test cases, focus areas, risk levels, and planned execution order.

Terminal organizes test cases by priority and function, highlights high-risk items, and offers controls for filtering and marking execution status.

### Step 20

User reviews the plan and interacts with test data on the terminal.

User inspects the presented test cases, priorities, and risk indicators, and can add comments, mark tests as completed, or request further generation for specific areas.

Input: visualized test data and user actions such as selections and commands.

Output: updated requests or status changes sent back to the server.

Terminal captures the user's operations, converts them into update messages, and transmits them to the server, allowing the system to refine or track test execution based on the integrated and continuously updated data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

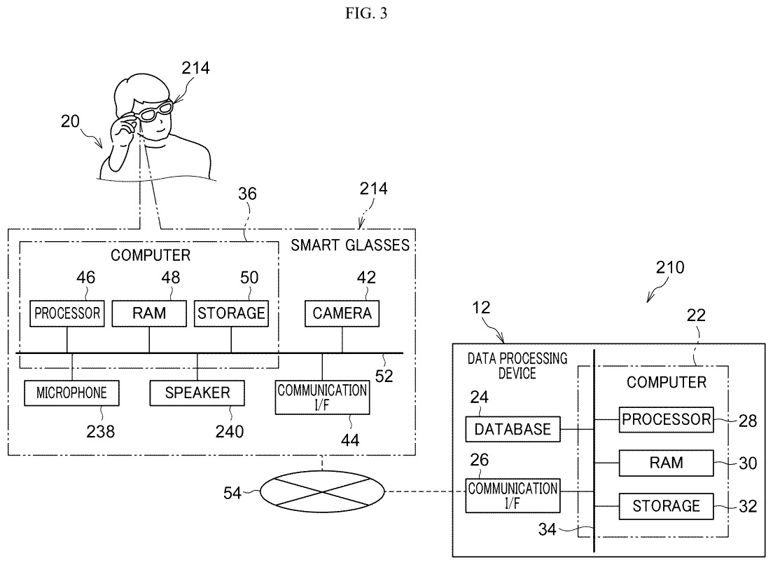

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

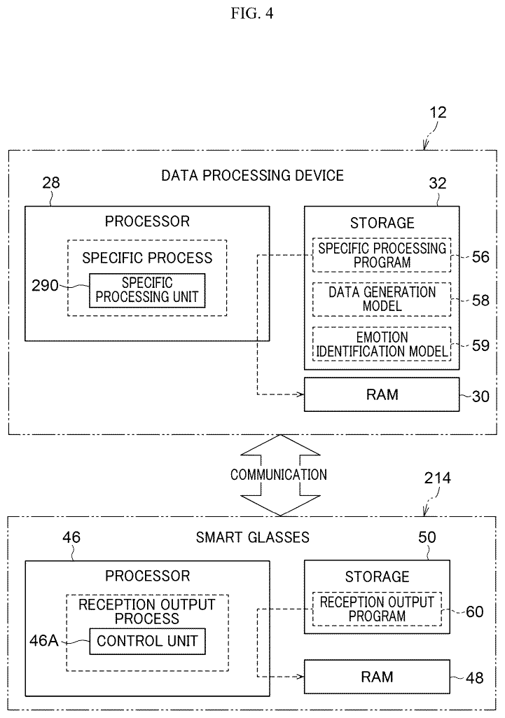

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

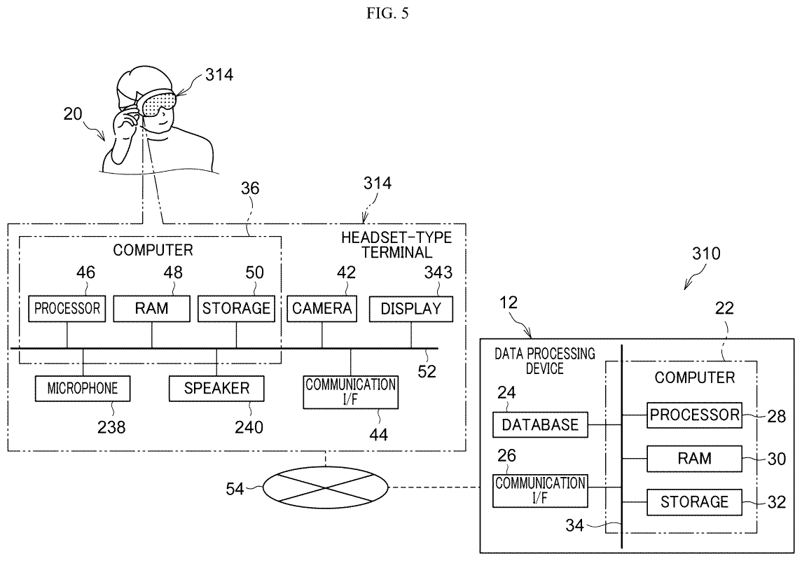

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

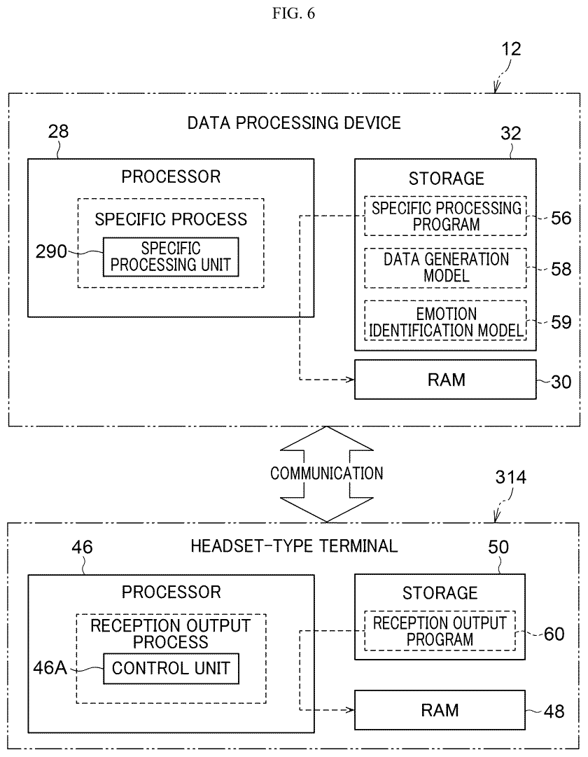

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

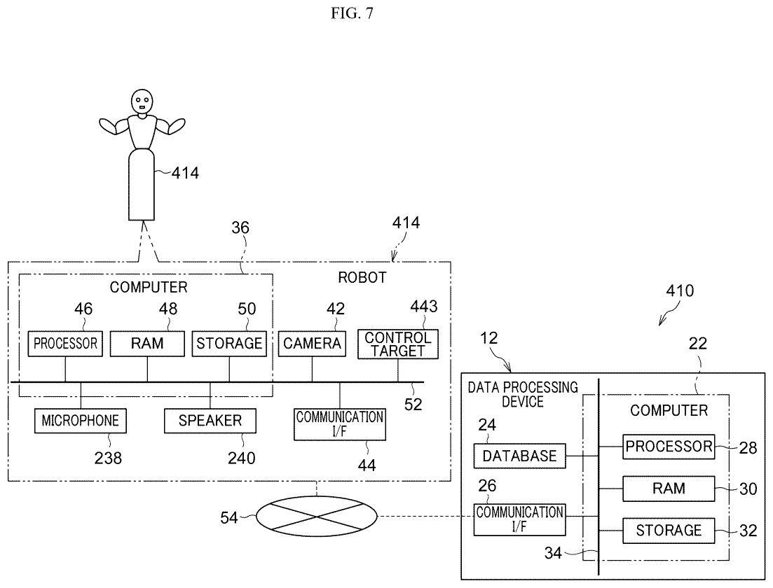

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

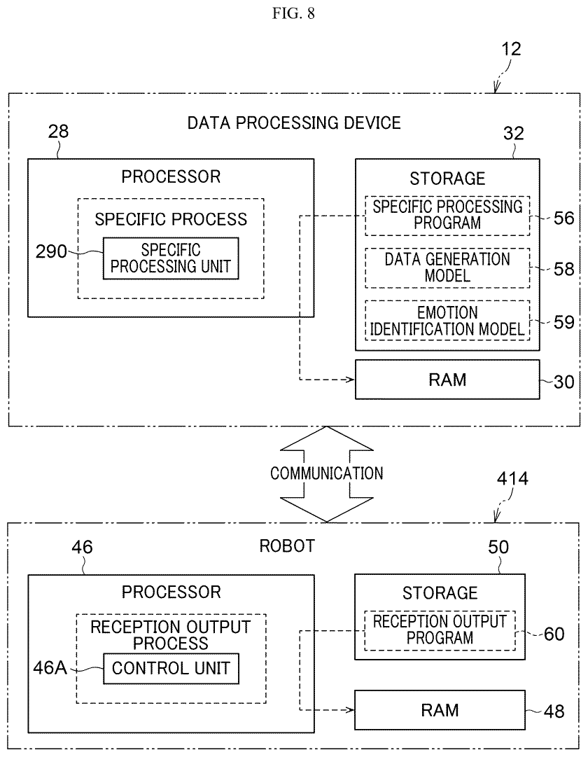

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

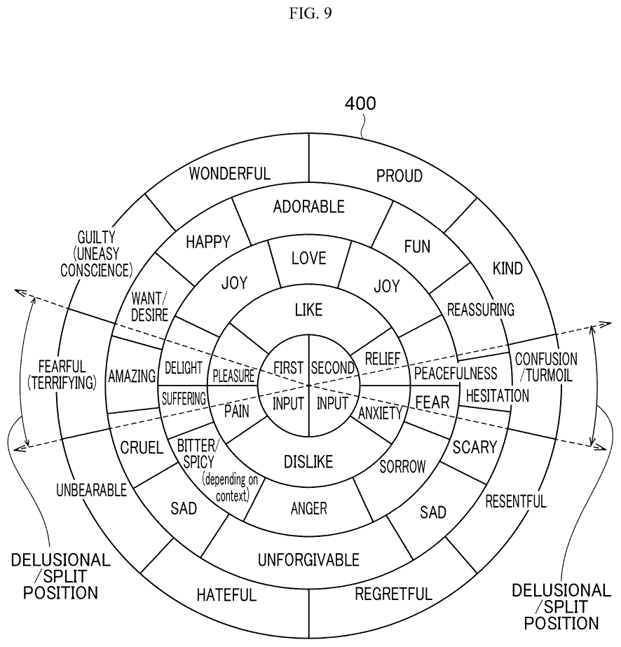

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

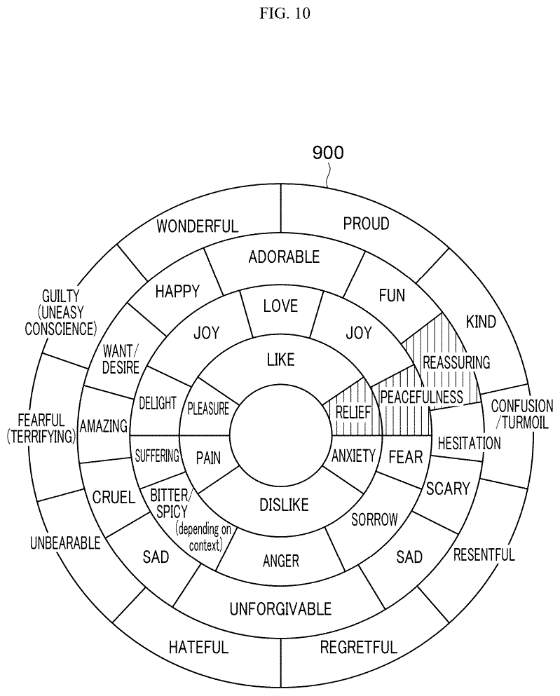

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive character information including functional requirements and performance requirements transmitted from a user terminal,
generate a prompt sentence that defines extraction items and an output format for syntactic information and semantic information of the received character information, input the prompt sentence and the character information into a generative information processing model, and acquire structured data of the character information from the generative information processing model,
generate test case information, based on the structured data, the test case information including normal operation scenarios and abnormal operation scenarios and having elements including a test identifier, a precondition, input information, operation steps, and an expected result,
use the generated test case information as input data to the generative information processing model, generate a prompt sentence to extract points of interest related to quality risk and safety risk, input the prompt sentence and the test case information into the
generative information processing model, and acquire important test point information from the generative information processing model,
generate a prompt sentence that instructs the generative information processing model to refer to the structured data, the test case information, the important test point information, accumulated defect case information, and defect pattern information, input the prompt sentence into the generative information processing model, and acquire defect factor information that identifies potential defect factors leading to occurrence of defects in a market, and
store, in a storage unit, the structured data, the test case information, the important test point information, and the defect factor information in association with one another, and generate output information to be provided to an external apparatus.

### Supplementary 2

The system according to supplementary 1,
wherein the processor is configured to
search past test information and past defect case information associated with the character information relating to a new function, generate a prompt sentence that defines conditions and a reference method for selecting reference information to be referred to by the generative information processing model based on similarity, input the prompt sentence into the generative information processing model, and cause the generative information processing model to perform analysis for improving coverage of the test case information.

### Supplementary 3

The system according to supplementary 1,
wherein the processor is configured to
use the structured data and the test case information as input, generate a prompt sentence that defines configuration elements and an output format of a prediction model for predicting potential defect occurrence locations based on the accumulated defect pattern information, input the prompt sentence into the generative information processing model, and identify, before introduction of a function, potential defects that may lead to defects in the market.

### Application Example 1

### Supplementary 1

A system comprising a processor,
wherein the processor is configured to
   receive, from a user via a terminal, functional requirements and performance specifications for a target apparatus and convert the functional requirements and the performance specifications into structured data,
generate, based on the structured data, a prompt sentence that instructs a generative artificial intelligence model to analyze the functional requirements and the performance specifications, and input the prompt sentence into the generative artificial intelligence model,
generate test case information, based on an analysis result output from the generative artificial intelligence model, the test case information including, for each test case, input conditions, expected behavior, and pass/fail determination conditions,
generate, based on the test case information, test scripts executable on the target apparatus that performs control processing or on a simulation environment that simulates the target apparatus,
execute the test scripts on the target apparatus or the simulation environment and acquire test result data including operation signals, state quantities, and time-series data, generate, based on the test result data, analysis input data including summary information and abnormality occurrence information, generate a prompt sentence that instructs the generative artificial intelligence model to extract potential fault factors and to present improvement proposals, and input the analysis input data together with the prompt sentence into the generative artificial intelligence model, and
generate, based on an analysis result output from the generative artificial intelligence model regarding the potential fault factors and the improvement proposals, report information including the functional requirements, the test case information, the test result data, and the analysis result, and provide the report information to the terminal.

### Supplementary 2

The system according to supplementary 1,
wherein the processor is configured to
generate the prompt sentence so as to include an instruction to the generative artificial intelligence model to perform analysis in consideration of similar cases contained in stored information representing historical test result data and historical fault information, in order to suppress occurrence of operational defects caused by insufficient testing at the time of introduction of a new function.

### Supplementary 3

The system according to supplementary 1,
wherein the processor is configured to
generate the prompt sentence so as to include an instruction to the generative artificial intelligence model to perform prediction processing that estimates probabilities of potential faults based on the analysis result and the test result data and to specify candidates of potential faults, in order to prevent, before introduction, faults that were previously overlooked and led to operational defects.

### Example 2

### Supplementary 1

A system comprising a processor,
wherein the processor is configured to
receive, via a communication apparatus, character information representing requirements and specifications of a target function from a user, and store the character information in a storage apparatus,
preprocess the character information stored in the storage apparatus by natural language processing to divide the character information into unit information sequences and convert the unit information sequences into numerical information sequences to be used as input information for a generative artificial intelligence model,
extract, from the requirements and specifications, functional elements, input conditions, output conditions, constraint conditions, and abnormal conditions, and generate a prompt sentence that instructs the generative artificial intelligence model to analyze the requirements and specifications based on extraction results,
provide the generative artificial intelligence model with the prompt sentence and the input information and execute an analysis process by the generative artificial intelligence model to obtain analysis result information including test condition information and risk information,
automatically construct, based on the analysis result information, test cases including a test identifier, a precondition, input data, an execution procedure, and an expected result, and generate the test cases as structured data,
generate, based on the analysis result information, test key point information indicating testing focus points to be checked with priority during testing and defect candidate information indicating potential defect elements, and store the test key point information and the defect candidate information in the storage apparatus in association with the test cases, and
output the test cases, the test key point information, and the defect candidate information to a user terminal, receive a correction instruction or an additional instruction from the user terminal, and re-input a prompt sentence including the correction instruction or the additional instruction to the generative artificial intelligence model to iteratively update at least one of the test cases, the test key point information, and the defect candidate information.

### Supplementary 2

The system according to supplementary 1,
wherein the processor is configured to
acquire, from the storage apparatus, past test information and past defect information, and, in generating the prompt sentence, generate a prompt sentence that instructs the generative artificial intelligence model to perform the analysis in consideration of similar cases based on the past test information and the past defect information in order to reduce a problem in which a test performed at a time of introduction of a new function is insufficient and a defect occurs in a market.

### Supplementary 3

The system according to supplementary 1,
wherein the processor is configured to
generate, in generating the prompt sentence, a prompt sentence that instructs the generative artificial intelligence model to construct a prediction mathematical model and identify potential defects based on the analysis result information and the past defect information in order to prevent, before introduction, defects that were previously overlooked and led to defects in a market, and output, as the defect candidate information, results obtained from the prediction mathematical model in association with the test cases.

### Application Example 2

### Supplementary 1

A system comprising a processor,
wherein the processor is configured to
receive functional requirements and performance requirements input by a user via an information processing device and store the functional requirements and the performance requirements in a storage region,
perform a structuring process using natural language processing on the functional requirements and the performance requirements to extract functional information, input condition information, output condition information, and constraint condition information,
generate a first prompt sentence including analysis target information comprising the extracted functional information, the input condition information, the output condition information, and the constraint condition information, and cause a generative artificial intelligence model to receive the first prompt sentence as input,
receive test case information, key test item information, and defect factor information output from the generative artificial intelligence model, and format the test case information as test data including test procedure information, expected result information, and test priority information,
perform importance calculation processing on the test data and the defect factor information based on past test history information and past defect history information, and assign risk evaluation information and recommended priority information to each test case,
convert evaluation information including an emotion input by a user into emotion type information and emotion intensity information by executing emotion analysis processing, and, based on the emotion type information and the emotion intensity information, adjust the recommended priority information for related test cases and generate a second prompt sentence including additional test request information,
cause the generative artificial intelligence model to receive the second prompt sentence as input to acquire enhanced test case information based on the emotion information, and integrate the enhanced test case information into the test data, and
transmit integrated test data, the key test item information, and the defect factor information to a terminal device and cause the terminal device to present the integrated test data, the key test item information, and the defect factor information as display data.

### Supplementary 2

The system according to supplementary 1,
wherein the processor is configured to
extract, from the test data, test cases related to physical operation, obtain operation condition information from the extracted test cases, convert the operation condition information into scenario information for verification in a virtual environment, execute simulation processing for operation verification using the scenario information for verification in the virtual environment, perform anomaly detection processing on operation log information obtained from the simulation processing, generate a third prompt sentence including detected abnormal event information, cause the generative artificial intelligence model to receive the third prompt sentence as input, acquire additional test case information and additional key test item information corresponding to the abnormal event information from the generative artificial intelligence model, and reflect the additional test case information and the additional key test item information in the test data.

### Supplementary 3

The system according to supplementary 1,
wherein the processor is configured to
generate integrated risk evaluation information based on the test case information,
the key test item information, and the defect factor information output from the generative artificial intelligence model, the emotion type information and the emotion intensity information obtained by the emotion analysis processing, and the abnormal event information obtained by the simulation processing for operation verification, determine execution order information and resource allocation information for the test cases in accordance with the integrated risk evaluation information, and provide a test plan including the execution order information and the resource allocation information to the terminal device.

What is claimed is:

1. A system comprising:
circuitry configured to:
receive, via a communication interface coupled to a packet-switched network, specification data comprising requirement parameters and program data associated with a target module;
generate, using a data generation model, modified program data based on the specification data and the program data, the data generation model comprising an encoder-decoder neural network that receives the specification data and an abstract syntax tree representation of the program data as multidimensional tensors and outputs the modified program data with an associated confidence score;
perform a validation operation on the modified program data by applying at least one of static analysis or automated test execution to the modified program data; and
generate a plurality of candidate program data sets by applying different inference parameters to the data generation model, each candidate program data set representing a distinct modification of the program data.

2. The system according to claim 1, wherein the specification data comprises at least one of functional requirements, non-functional requirements, or constraint conditions for a ticket in an agile development workflow.

3. The system according to claim 1, wherein the circuitry is further configured to perform preprocessing on the specification data comprising tokenization and syntactic analysis, and to perform preprocessing on the program data comprising conversion to the abstract syntax tree representation and generation of a dependency graph.

4. The system according to claim 1, wherein the encoder-decoder neural network comprises a Transformer-based architecture, and wherein the circuitry is further configured to apply temperature parameters and top-K sampling during inference to generate the plurality of candidate program data sets.

5. The system according to claim 1, wherein the circuitry is further configured to attach, to each of the plurality of candidate program data sets, highlight information identifying changed portions of the program data and explanatory text indicating a basis for the modification.

6. The system according to claim 1, wherein the different inference parameters comprise at least one of different temperature parameters, different pre-trained models, or different prompt configurations.

7. The system according to claim 1, wherein the input data further comprises image data, and the circuitry is further configured to extract a feature map from the image data using a convolutional neural network, and concatenate feature data extracted from the feature map with the subword token array before inputting into the Transformer-based neural network.

8. The system according to claim 1, wherein the circuitry is further configured to apply the Transformer-based neural network to generate a confidence score for the structured query statement, compare the confidence score against a threshold value, and transmit the structured query statement to the client terminal only when the confidence score meets or exceeds the threshold value.

9. The system according to claim 1, wherein the circuitry is further configured to retrieve, from an input history database, past input records associated with a user identifier of the client terminal, input the past input records into a time-series recurrent neural network to generate a prediction of a next input method and candidate input content, and transmit the candidate input content to the client terminal.

10. The system according to claim 1, wherein the circuitry is further configured to receive a partial token sequence from the client terminal, input the partial token sequence into a language model to generate completion candidates comprising next token predictions mapped to a syntax tree of the structured query statement, and transmit the completion candidates to the client terminal.

11. The system according to claim 1, wherein the circuitry is further configured to receive emotion-related data from the client terminal, input the emotion-related data into an emotion identification model to generate an emotion category and an emotion intensity score, and adjust a processing parameter of the structured query statement generation based on the emotion intensity score.

12. The system according to claim 11, wherein the emotion-related data comprises at least one of a voice spectrogram, a facial image feature map, or a biometric signal vector, and the emotion identification model comprises a multimodal Transformer that integrates features across the at least one of the voice spectrogram, the facial image feature map, or the biometric signal vector.

13. The system according to claim 1, wherein the circuitry is further configured to execute the modified program data as an executable test script by transmitting control commands to an external apparatus or simulator via the communication interface, receive raw test result data comprising time-stamped operation signals and state quantities from the external apparatus or simulator during execution, and construct structured analysis input data by computing summary metrics from the raw test result data and comparing the summary metrics against threshold values.

14. The system according to claim 13, wherein the circuitry is further configured to convert the modified program data into a simulation scenario representation comprising operation condition information, invoke a simulation program that computes physical quantities over time to generate operation log information, compute derived features from the operation log information comprising at least one of positional deviation values, peak acceleration derivative values, or contact event counts, and apply an anomaly detection algorithm to the derived features to generate anomaly scores and abnormal event information.

15. The system according to claim 14, wherein the circuitry is further configured to construct an additional prompt sentence comprising the abnormal event information and the anomaly scores, transmit the additional prompt sentence to the data generation model, and receive from the data generation model additional test case data and additional test point data directed to investigating and mitigating the detected anomalies.

16. The system according to claim 1, wherein the circuitry is further configured to receive update request data from a terminal device, the update request data comprising references to existing requirement identifiers and changed text segments, construct an updated prompt sentence incorporating the changed text segments and previously stored structured data, and transmit the updated prompt sentence to the data generation model to generate updated candidate program data sets reflecting the changed text segments.

17. The system according to claim 1, wherein the circuitry is further configured to store the structured query statement and a corresponding user identifier in a query history database, and input the stored query history data into the Transformer-based neural network as additional context features when generating a subsequent structured query statement for the same user identifier.

18. A system comprising:
circuitry configured to:
receive, via a communication interface coupled to a packet-switched network, input data from a client terminal, wherein the input data comprises a natural-language token sequence having a maximum length of 512 to 2048 tokens;
apply a tokenizer to the natural-language token sequence to generate a subword token array;
input the subword token array into a Transformer-based neural network comprising an encoder layer having parameters numbering in a range of one billion to one hundred billion, the encoder layer extracting structural feature data comprising table identifiers, column identifiers, conditional operators, and join relationships from the subword token array;
retrieve database schema information comprising structured data specifying table names, column names, data type information, and index information;
generate, by mapping the structural feature data and the database schema information in a high-dimensional semantic space of the Transformer-based neural network, a structured query statement represented as an abstract syntax tree comprising a token sequence of query keywords, table references, column references, and conditional expressions;
compute a confidence score for the structured query statement and compare the confidence score against a threshold value; and
transmit, via the communication interface, response data comprising the structured query statement to the client terminal when the confidence score meets or exceeds the threshold value.

19. The system according to claim 18, wherein the circuitry is further configured to compare the database schema information against previously stored schema data using a difference detection algorithm, detect addition of a new column, and automatically incorporate the new column into the structured query statement by updating the abstract syntax tree.

20. A method performed by circuitry, via a communication interface coupled to a packet-switched network, the method comprising:
receiving specification data comprising requirement parameters and program data associated with a target module;
generating, using a data generation model, modified program data based on the specification data and the program data, the data generation model comprising an encoder-decoder neural network that receives the specification data and an abstract syntax tree representation of the program data as multidimensional tensors and outputs the modified program data with an associated confidence score;
performing a validation operation on the modified program data by applying at least one of static analysis or automated test execution to the modified program data; and
generating a plurality of candidate program data sets by applying different inference parameters to the data generation model, each candidate program data set representing a distinct modification of the program data.
